(19) United States
(12) Patent Application Publication
(10) Pub. No.: US 2022/0237597 A1
(43) Pub. Date: Jul. 28, 2022

(54) ALTERNATIVE DIGITAL ASSET CONVERSION CHOICES

(71) Applicant: Bakkt Marketplace, LLC, Atlanta, GA (US)

(72) Inventors: Christopher Michael Petersen, Lakeway, TX (US); Jeffrey Scott Pittelkau, Montgomery, AL (US); Nikolais Linsteadt, Applegate, CA (US); Joseph Arthur Revnes, Atlanta, GA (US); Brian Daniel Cooper, Marietta, GA (US); William Matthau, Laguna Niguel, CA (US); Yamini Bistesh Sagar, Alpharetta, GA (US); Nicolas Frederic Cabrera, Atlanta, GA (US); Utkarsh Agarwal, Tucson, AZ (US); Tim Kuchlein, Cupertino, CA (US); Bharath Lakshmanan, San Ramon, CA (US); William Andrew Bryant, Alpharetta, GA (US); Stephen Paul Saucier, Atlanta, GA (US); Deepak Kumar, Marietta, GA (US); Anil Jaiswal, Marietta, GA (US); Byungkwon Jeon, Cumming, GA (US); Balaji Devarasetty, Atlanta, GA (US)

(21) Appl. No.: 17/397,810

(22) Filed: Aug. 9, 2021

Related U.S. Application Data
(63) Continuation of application No. 63/199,751, filed on Jan. 22, 2021.

(51) Int. Cl. G06Q 20/38; G06F 9/54

(52) U.S. Cl. CPC G06Q 20/381; G06F 9/54

(57) ABSTRACT

Various embodiments are directed to providing digital asset conversion choices involving different digital assets. An example method includes receiving a first digital asset conversion request associated with an end user and indicating a source digital asset and determining a source conversion rate for the source digital asset using an application programming interface (API). The method further includes identifying one or more alternative digital assets; determining an aggregated conversion rate between each alternative digital asset and the source digital asset by identifying the end user and using an API; providing an indication of the alternative digital assets and corresponding aggregated conversion rates for display via a client device; and responsive to receiving a second digital asset conversion request comprising a selection of an alternative digital asset, executing a digital asset conversion by causing debiting of units of the source digital asset and crediting of units of the selected alternative digital asset.

### CROSS-REFERENCE TO RELATED APPLICATIONS

This application claims the benefit of U.S. Provisional Patent Application Ser. No. 63/199,751 filed on Jan. 22, 2021, which is incorporated herein by reference in its entirety, including any figures, tables, drawings, and appendices.

### TECHNOLOGICAL FIELD

Embodiments of the present disclosure generally relate to transacting, exchanging, transferring, managing, executing transactions for, and/or the like digital assets and fiat currency.

### BACKGROUND

Various embodiments of the present disclosure address technical challenges related to converting digital assets to fiat currency and/or different digital assets, managing the processing of such conversions and transactions, and improving the efficiency of such processing.

### BRIEF SUMMARY

In general, embodiments of the present disclosure provide methods, apparatus, systems, computing devices, computing entities, and/or the like for providing alternative digital asset conversion choices or options. Alternative digital asset conversion choices or options are provided during execution of a digital asset conversion requested by an end user of a client device. In various example instances, the end user may request the conversion of units of a first digital asset (a source digital asset) to one of (i) units of a fiat currency, or (ii) units of a second digital asset (a target digital asset). In either conversion scenario, alternative digital assets are selected and indicated to the end user as an alternative option or diversion from the originally requested fiat currency or target digital asset. In various embodiments, the alternative digital assets are selected based at least in part on behavioral data associated with the end user and/or conversion rates for the source digital asset and/or the target digital asset.

When presented with the alternative digital asset conversion choices, the end user may select to continue with the originally requested digital asset conversion (e.g., to the fiat currency, to the target digital asset) or may request the conversion of units of the source digital asset to units of a selected alternative digital asset (an alternative digital asset conversion). Execution of the originally requested digital asset conversion then involves the debit of source digital asset units from a source digital asset user account and the credit of one of (i) fiat currency units to a fiat currency user account, or (ii) target digital asset units to a target digital asset user account. Execution of the alternative digital asset conversion in contrast involves the debit of source digital asset units from the source digital asset user account and the credit of alternative digital asset units to an alternative digital asset user account. Unit amounts in each debit and credit are determined based at least in part on conversion rates associated with the source digital asset, target digital asset, and each alternative digital asset.

In accordance with one aspect, a computer-implemented method is provided. The method includes receiving a first digital asset conversion request indicating a source digital asset and one of (i) a fiat currency or (ii) a target digital asset. The first digital asset conversion request is associated with a first timepoint. The method further includes determining a first source conversion rate for the source digital asset and the fiat currency based at least in part on generating and transmitting a first source conversion rate application programming interface (API) request, the first source conversion rate API request indicating a source digital asset and including an identifier token associated with an end user, and receiving a first source conversion rate API response including the first source conversion rate for the source digital asset and the fiat currency. The method further includes, responsive to determining that a first configurable time period has elapsed since the first timepoint, determining a second source conversion rate for the source digital asset and the fiat currency based at least in part on generating and transmitting a second source conversion rate API request and receiving a second source conversion rate API response including the second source conversion rate for the source digital asset and the fiat currency.

The method further includes identifying one or more alternative digital assets based at least in part on the identifier token associated with the end user. Each alternative digital asset is different from the target digital asset. The method further includes, for each alternative digital asset, determining an alternative conversion rate for a corresponding alternative digital asset and the fiat currency based at least in part on generating and transmitting an alternative conversion rate API request, the first alternative conversion rate API request indicating the corresponding alternative digital asset and including an identifier token associated with the end user, and receiving an alternative conversion rate API response including the alternative conversion rate for the corresponding alternative digital asset and the fiat currency. The method further includes, for each alternative digital asset, generating an aggregated conversion rate for the source digital asset and the corresponding alternative digital asset based at least in part on the second source conversion rate and a corresponding alternative conversion rate, and providing an indication of the one or more alternative digital assets and each corresponding aggregated conversion rate for display via a client device. The indication is provided in response to the first digital asset conversion request.

The method further includes, responsive to receiving a second digital asset conversion request at a second timepoint indicating (i) a selected alternative digital asset of the one or more alternative digital assets, (ii) both a source digital asset user account and an alternative digital asset user account each identifiable by the identifier token associated with the end user, and (iii) an amount of source digital asset units: executing a digital asset conversion for the second digital asset conversion request within a second configurable time period, dynamically providing a notification of execution of the digital asset conversion via the client device, and updating a first account balance data object associated with the source digital asset user account and a second account balance data object associated with the alternative digital asset user account based at least in part on the digital asset conversion. The executing of the digital asset conversion includes causing debiting of the amount of source digital asset units from the source digital asset user account and causing crediting of an amount of units of the selected alternative digital asset to the alternative digital asset user account.

In accordance with another aspect, a system is provided. The system includes one or more memory storage areas and one or more processors. The system is configured for receiving a first digital asset conversion request indicating a source digital asset and one of (i) a fiat currency or (ii) a target digital asset. The first digital asset conversion request is associated with a first timepoint. The system is further configured for determining a first source conversion rate for the source digital asset and the fiat currency based at least in part on generating and transmitting a first source conversion rate application programming interface (API) request, the first source conversion rate API request indicating a source digital asset and including an identifier token associated with an end user, and receiving a first source conversion rate API response including the first source conversion rate for the source digital asset and the fiat currency. The system is further configured for, responsive to determining that a first configurable time period has elapsed since the first timepoint, determining a second source conversion rate for the source digital asset and the fiat currency based at least in part on generating and transmitting a second source conversion rate API request and receiving a second source conversion rate API response including the second source conversion rate for the source digital asset and the fiat currency.

The system is further configured for identifying one or more alternative digital assets based at least in part on the identifier token associated with the end user. Each alternative digital asset is different from the target digital asset. The system is further configured for, for each alternative digital asset, determining an alternative conversion rate for a corresponding alternative digital asset and the fiat currency based at least in part on generating and transmitting an alternative conversion rate API request, the first alternative conversion rate API request indicating the corresponding alternative digital asset and including an identifier token associated with the end user, and receiving an alternative conversion rate API response including the alternative conversion rate for the corresponding alternative digital asset and the fiat currency. The system is further configured for, for each alternative digital asset, generating an aggregated conversion rate for the source digital asset and the corresponding alternative digital asset based at least in part on the second source conversion rate and a corresponding alternative conversion rate, and providing an indication of the one or more alternative digital assets and each corresponding aggregated conversion rate for display via a client device. The indication is provided in response to the first digital asset conversion request.

The system is further configured for, responsive to receiving a second digital asset conversion request at a second timepoint indicating (i) a selected alternative digital asset of the one or more alternative digital assets, (ii) both a source digital asset user account and an alternative digital asset user account each identifiable by the identifier token associated with the end user, and (iii) an amount of source digital asset units: executing a digital asset conversion for the second digital asset conversion request within a second configurable time period, dynamically providing a notification of execution of the digital asset conversion via the client device, and updating a first account balance data object associated with the source digital asset user account and a second account balance data object associated with the alternative digital asset user account based at least in part on the digital asset conversion. The executing of the digital asset conversion includes causing debiting of the amount of source digital asset units from the source digital asset user account and causing crediting of an amount of units of the selected alternative digital asset to the alternative digital asset user account.

In accordance with yet another aspect, a computer program product is provided. The computer program product includes at least one non-transitory computer-readable storage medium having computer-readable program code portions stored therein. The computer-readable program code portions include executable portions configured for receiving a first digital asset conversion request indicating a source digital asset and one of (i) a fiat currency or (ii) a target digital asset. The first digital asset conversion request is associated with a first timepoint. The computer-readable program code portions include executable portions further configured for determining a first source conversion rate for the source digital asset and the fiat currency based at least in part on generating and transmitting a first source conversion rate application programming interface (API) request, the first source conversion rate API request indicating a source digital asset and including an identifier token associated with an end user, and receiving a first source conversion rate API response including the first source conversion rate for the source digital asset and the fiat currency. The computer-readable program code portions include executable portions further configured for, responsive to determining that a first configurable time period has elapsed since the first timepoint, determining a second source conversion rate for the source digital asset and the fiat currency based at least in part on generating and transmitting a second source conversion rate API request and receiving a second source conversion rate API response including the second source conversion rate for the source digital asset and the fiat currency.

The computer-readable program code portions include executable portions further configured for identifying one or more alternative digital assets based at least in part on the identifier token associated with the end user. Each alternative digital asset is different from the target digital asset. The computer-readable program code portions include executable portions further configured for, for each alternative digital asset, determining an alternative conversion rate for a corresponding alternative digital asset and the fiat currency based at least in part on generating and transmitting an alternative conversion rate API request, the first alternative conversion rate API request indicating the corresponding alternative digital asset and including an identifier token associated with the end user, and receiving an alternative conversion rate API response including the alternative conversion rate for the corresponding alternative digital asset and the fiat currency. The computer-readable program code portions include executable portions further configured for, for each alternative digital asset, generating an aggregated conversion rate for the source digital asset and the corresponding alternative digital asset based at least in part on the second source conversion rate and a corresponding alternative conversion rate, and providing an indication of the one or more alternative digital assets and each corresponding aggregated conversion rate for display via a client device. The indication is provided in response to the first digital asset conversion request.

The computer-readable program code portions include executable portions further configured for, responsive to receiving a second digital asset conversion request at a second timepoint indicating (i) a selected alternative digital asset of the one or more alternative digital assets, (ii) both a source digital asset user account and an alternative digital asset user account each identifiable by the identifier token associated with the end user, and (iii) an amount of source digital asset units: executing a digital asset conversion for the second digital asset conversion request within a second configurable time period, dynamically providing a notification of execution of the digital asset conversion via the client device, and updating a first account balance data object associated with the source digital asset user account and a second account balance data object associated with the alternative digital asset user account based at least in part on the digital asset conversion. The executing of the digital asset conversion includes causing debiting of the amount of source digital asset units from the source digital asset user account and causing crediting of an amount of units of the selected alternative digital asset to the alternative digital asset user account.

### BRIEF DESCRIPTION OF THE DRAWING(S)

Having thus described the present disclosure in general terms, reference will now be made to the accompanying drawings, which are not necessarily drawn to scale, and wherein:

FIG. 1 is an exemplary diagram of a system architecture, in accordance with various embodiments of the present disclosure;

FIG. 2 is an exemplary schematic of an account management system, in accordance with various embodiments of the present disclosure;

FIG. 3 is an exemplary schematic of a client device node, in accordance with various embodiments of the present disclosure;

FIG. 4 provides a flowchart diagram describing an example process for initiating a digital asset conversion, in accordance with various embodiments of the present disclosure;

FIG. 5 provides a flowchart diagram describing an example process for identifying and providing alternative digital asset conversion choices, in accordance with various embodiments of the present disclosure;

FIG. 6 provides a flowchart diagram describing an example process for executing a digital asset conversion, in accordance with various embodiments of the present disclosure;

FIG. 7 provides a flowchart diagram describing an example process for executing a digital asset conversion, in accordance with various embodiments of the present disclosure;

FIG. 8 provides a flowchart diagram describing an example process for executing a digital asset conversion, in accordance with various embodiments of the present disclosure; and

FIGS. 9-14 provide example interfaces for configuring a digital asset conversion for execution, in accordance with various embodiments of the present disclosure.

### DETAILED DESCRIPTION OF SOME EXAMPLE EMBODIMENTS

Various embodiments of the present disclosure now will be described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” (also designated as “/”) is used herein in both the alternative and conjunctive sense, unless otherwise indicated. The terms “illustrative” and “exemplary” are used to be examples with no indication of quality level. Like numbers refer to like elements throughout.

### I. GENERAL OVERVIEW AND TECHNICAL ADVANTAGES

Various embodiments of the present disclosure are generally directed to providing alternative digital asset conversion choices or options during execution of a digital asset conversion requested by an end user of a client device. While an originally requested digital asset conversion may be a conversion of a source digital asset to a fiat currency or to a target digital asset, alternative digital asset are preemptively, automatically, and intelligently selected for the end user and presented as an alternative to the originally requested digital asset conversion. Various embodiments then involve the execution of an alternative digital asset conversion of a source digital asset to a selected alternative digital asset. In general, various embodiments are directed to the efficient, accurate, and secure execution of a digital asset conversion from a source digital asset to one of (i) an originally requested fiat currency, (ii) an originally requested target digital asset, or (iii) a selected alternative digital asset, responsive to end user selection. In doing so, various embodiments involve efficient technical communication with a variety of digital asset exchange systems that each manage a digital asset in order to promptly execute a digital asset conversion in a flexible and advantageous manner.

Various embodiments advantageously reduce the amount of user interactions and/or network communications performed by an end user by preemptively, automatically, and intelligently identifying alternative digital assets for an end user. In various embodiments, alternative digital assets are identified based at least in part on behavioral data associated with the end user. Identified alternative digital assets may be predictive in being associated with a significant probability that the end user would be interested in being credited with units of the identified alternative digital assets. Accordingly, preemptive and intelligent identification of alternative digital assets advantageously precludes an end user from exploring and navigating throughout a volume of different digital asset options, which consumes valuable time and resources. Identified alternative digital assets are further presented as alternative digital asset conversion choices to the end user, each alternative digital asset conversion choice being executable responsive to a reduced amount of user interactions, processing resources, and network communication. In various embodiments, each alternative digital asset conversion choice comprises a conversion rate for the alternative digital asset determined automatically, thereby eliminating the need for an end user to manually request a conversion rate for the alternative digital asset.

Digital asset conversions executed in various embodiments of the present disclosure are advantageously efficient with regards to execution and processing time. Upon execution of a digital asset conversion, an end user receives in possession units of the desired fiat currency, target digital asset, or alternative digital asset within milliseconds or seconds. In contrast, existing systems and methods involve longer execution and processing times, resulting in the end user receiving converted units on a scale of days or weeks. In some embodiments, the efficiency of digital asset conversions is in part enabled by communication with digital asset exchange systems via application programming interfaces (API). For example, a conversion execution API request may be transmitted to a digital asset exchange system to cause fiat currency units, target digital asset units, or alternative digital asset units to promptly be credited to a user account associated with the end user.

Such direct communication with digital asset exchange systems further provides technical advantages in end user security and confidentiality. Existing systems and methods may enable a first end user to exchange units of a digital asset with units of another digital asset owned by a second end user, essentially being a transaction between two end users. In various embodiments of the present disclosure however, execution of a digital asset conversion for an end user does not involve communication with other end users, thereby preserving security for end user data and communications. Instead, the execution of a digital asset conversion for an end user involves communication with one or more digital asset exchange systems (not associated with any particular end user) to debit and/or credit units of various fiat currencies and/or digital assets from and to user accounts associated with the end user.

Further, various embodiments provide technical advantages by providing current, real-time, and accurate information relating to digital asset conversions to end users. In particular, various embodiments involve determining conversion rates for various digital assets to determine amounts of units to debit and/or credit during execution of a digital asset conversion. Such conversion rates are determined in real-time in order to ascertain the most current and accurate value worth of various digital assets. Even further, various embodiments involve determining such conversion rates based at least in part on automated timing triggers for configurable time periods. That is, expiration of a configurable time period may prompt a new conversion rate to be determined. This is applied in various embodiments to provide (e.g., display) accurate information regarding the worth of various digital assets to an end user. Such automated timing triggers and configurable time periods are further applied to prevent inaccurate digital asset conversions from being requested by an end user. In some embodiments, an automated timing trigger may cause an end user to re-request or re-specify a digital asset conversion when previous requests or specifications may be outdated. Informational accuracy automatically provided by various aspects of various embodiments may result in further technical advantages by reducing the amount of user interactions and/or network communications performed by an end user to ascertain detailed information for a digital asset conversion.

### II. EXEMPLARY DEFINITIONS

The term “digital asset” may generally refer to any data entity that is perceived to hold value. For example, a digital asset may be a cryptoasset or cryptocurrency (e.g., a cryptocurrency digital asset), a liability digital asset such as loyalty points or reward points, an in-game asset or ecosystem-specific asset, and/or the like. For such digital assets, the supply of the digital asset may include multiple digital asset units. A digital asset unit of a digital asset may be understood as a quantification or basis of the digital asset, such as an individual Bitcoin (BTC), one corporate loyalty point, and/or the like. A digital asset may be quantified, managed, transacted, and/or the like based at least in part on full and/or fractional units. For example, a digital asset transaction may involve one BTC unit, two BTC units, one-hundred BTC units, and/or the like (full units), while another digital asset transaction may involve 0.4 BTC units, 1.5 BTC units, 0.0150 BTC units, and/or the like (fractional units). A digital asset may also be a single-unit digital asset, such as a non-fungible token (NFT) or an ownership token. A digital asset is associated with value and may be used to purchase goods and services or be exchanged for fiat currency. By extension, a digital asset may be exchanged for another digital asset of equivalent value, or an amount of digital asset units of a first digital asset may be exchanged for an amount of digital asset units of a second digital asset, using fiat currency as an equivalence basis of value. A digital asset may be a strictly digital construct and may not exist in a physical state.

The term “fiat currency” may refer to a currency that is not necessarily related to or backed by a physical commodity. A fiat currency may be centrally managed and distributed by a central entity. Examples of fiat currencies may include U.S. dollars (USD, $), European Union (EU) euros, Chinese yen, English pounds, and/or the like that are managed and distributed by respective governments. The central entity managing a fiat currency may have the authority to increase and/or decrease the supply of a fiat currency. A fiat currency has inherent transactional value, which may be based at least in part on a relationship between the supply of the fiat currency and the demand of the fiat currency. Thus, the value of fiat currency may be managed by a central entity. The value of fiat currency may be used as a reference for evaluating a variable value of a digital asset. A fiat currency may be quantified by fiat currency units. For example, one unit of a U.S. dollar fiat currency may be understood as a single dollar or a single cent. Value of various digital assets and other purchased goods or services may be described by an amount of fiat currency units.

The term “conversion rate” may refer to a data entity describing a value (e.g., a transactional value) of a digital asset. Specifically, a conversion rate may describe the value of a digital asset with respect to a fiat currency or with respect to another digital asset. For example, a conversion rate for a liability digital asset may indicate that one unit of the liability digital asset (e.g., one reward point) is worth or equal in value to ten fiat currency units (e.g., USD $10). As another example, a conversion rate for the liability digital asset may indicate that one unit of the liability digital asset is worth or equal in value to one-tenth of a unit of a cryptocurrency digital asset (e.g., 0.1 BTC). As also shown, a conversion rate may describe a full and/or fractional value of a digital asset. A conversion rate may be historical, indicative, current, and/or real-time. In one example, a historical or indicative conversion rate may describe the variable value of a digital asset over a previous or past time period. Accordingly, conversion rates may be associated with timepoints and/or be labelled with timestamps. A current or real-time conversion rate may describe the value of a digital asset at a present moment in time and may be continuously dynamic or variable. Accordingly, a conversion rate may be continuously and periodically updated so as to accurately describe the current or real-time value of a digital asset (e.g., with respect to a fiat currency, with respect to another digital asset).

The term “aggregated conversion rate” may refer to a conversion rate between two digital assets and determined using fiat currency as a common basis or reference. An aggregated conversion rate then describes the value of a first digital asset with respect to a second digital asset. An aggregated conversion rate between two digital assets may be generated using conversion rates for each digital asset each with respect to fiat currency in a transitive (to some extent) manner. For example, an aggregated conversion rate indicating that a unit of a first digital asset is worth ten units of a second digital asset may be generated based at least in part on the first digital asset being worth five fiat currency units and the second digital asset being worth 0.5 fiat currency units. In various instances, aggregated conversion rates are non-uniform and may be dependent on various constraints associated with each conversion rate associated with the first and the second digital asset. For example, an indicated worth of a first digital asset may only be valid for certain units amounts, thus limiting a uniform validity of an aggregated conversion rate between the first digital asset and a second digital asset.

The term “identifier token” may refer to a data entity associated with an end user of a client device and may be configured to identify the end user. As used and described herein, an identifier token may be a unique identifier token associated with the end user, and thus, each end user that may communicate with an account management system may be associated and assigned with a unique identifier token. An identifier token may also be a federated, global, universal, and/or the like identifier token configured to identify the same end user in various systems. For example, the identifier token may be used to identify the end user in an account management system, and the same identifier token may be used to identify the end user in various different digital asset exchange systems. The identifier token may include various identifying information for an end user, such as name, birthdate, Social Security Number, and/or the like. The identifier token may be and/or comprise a globally unique identifier (GUID), a universally unique identifier (UUID), a hash or cryptographic value of user information or credentials, and/or the like.

The term “account balance data object” may refer to a data entity configured to describe at least an amount of units stored in, associated with, and/or linked to an account. For example, an account balance data object for a fiat currency account (e.g., a fiat currency user account) may describe the number of fiat currency units associated with the fiat currency account. Likewise, an account balance data object for a digital asset account (e.g., a digital asset user account) may describe the number of digital asset units of a digital asset associated with the digital asset account. In some instances, an account balance data object may be a nested account balance data object; that is, an account balance data object associated with a particular digital asset may comprise and/or be otherwise associated with one or more other account balance data objects also associated with the same particular digital asset. An account balance data object comprising one or more nested account balance data objects each corresponding to a user account may indicate, describe, and/or the like a total number of units associated with all of the corresponding user accounts. An account balance data object may comprise additional information for a corresponding account, such as global or account-specific account identifiers, historical balance data, owner entity credentials, and/or the like. Thus, when any account is referenced herein, one or more account balance data objects may be used to record transactions, conversions, transfers, and/or the like that may cause changes (e.g., an increase, a decrease) to the number of digital asset units associated with an account. Such an account balance data object may indicate or describe entities involved in a transaction, conversion, transfer, and/or the like, entities associated with a corresponding account, fiat currencies, fiat currency units, a digital asset, a cost basis, an exchange rate, a conversion rate, timestamps, and/or the like.

The term “conversion behavior cohort” may refer to a plurality of end users that are each similar in some aspect to others of the plurality. The conversion behavior cohort may be associated with a data entity configured to identity and/or describe such plurality of end users. Various information related to each end user (e.g., name, birthdate, Social Security number, permanent address, account identifiers) may then be stored within a conversion behavior cohort. Various aspects for grouping end users in a conversion behavior cohort may include demographic information (e.g., age, location) and/or other information associated with the end user, conversion and/or transaction behavior, account information, and/or the like. For example, a first conversion behavior cohort may include end users who have historically never requested a digital asset conversion, a second conversion behavior cohort may include end users who have historically only requested a digital asset conversion for certain exchange rates, and a third conversion behavior cohort may include end users who have historically requested digital asset conversions in a liberal manner. As another example, a first conversion behavior cohort may include end users who own digital asset user accounts of a first tier, status, and/or the like, and a second conversion behavior cohort may include end users who own digital asset user accounts of a second tier, status, and/or the like. A conversion behavior cohort may identify end users based at least in part on an individual aspect or any combination of aspects.

The term “conversion behavior analytics data object” may refer to a data entity configured to describe conversion and/or transaction behavior of an end user and/or a conversion behavior cohort. For example, a conversion behavior analytics data object may indicate a popular exchange rate at which a high number of digital asset conversions were requested and executed. A conversion behavior analytics data object may also include predictive analytics that may indicate a likelihood of an end user and/or a conversion behavior cohort requesting a digital asset conversion at a particular exchange rate. Thus, a conversion behavior analytics data object may be generated at least in part on a predictive model, optimization model, classification model, neural network model, supervised or unsupervised machine learning model, and/or the like configured to generate predictive analytics.

### III. COMPUTER PROGRAM PRODUCTS, METHODS, AND COMPUTING ENTITIES

Embodiments of the present disclosure may be implemented in various ways, including computer program products that comprise articles of manufacture. Such computer program products may include one or more software components including, for example, software objects, methods, data structures, or the like. A software component may be coded in any of a variety of programming languages. An illustrative programming language may be a lower-level programming language, such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### IV. EXEMPLARY SYSTEM ARCHITECTURE

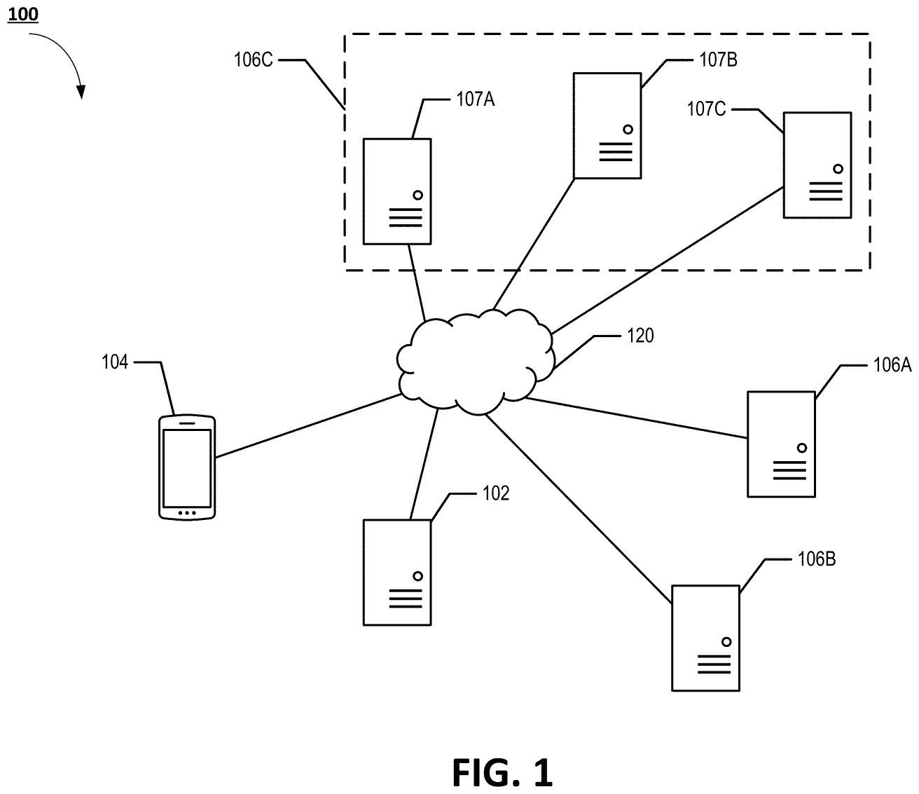

FIG. 1 provides an illustration of an architecture 100 that can be used in conjunction with various embodiments of the present disclosure. As shown in FIG. 1, the architecture 100 may comprise one or more account management systems 102, one or more client devices 104, one or more digital asset exchange systems 106, one or more networks 120, and/or the like. In various embodiments, an account management system 102 is configured to communicate with a plurality of client devices 104 and execute digital asset conversions (e.g., conversion of a source digital asset to fiat currency, conversion of a source digital asset to a target digital asset, conversion of a source digital asset to an alternative digital asset) for a plurality of end users associated with the plurality of client devices 104. In various embodiments, an account management system 102 may communicate with one or more digital asset exchange systems 106 for the execution of a digital asset conversion for an end user of a client device 104. The account management system 102 may communicate with a digital asset exchange system 106 at least to determine a conversion rate for a digital asset (e.g., a source digital asset, a target digital asset, an alternative digital asset), to cause the debiting of digital asset units from a digital asset user account, to cause the crediting of digital asset units to a digital asset user account, and to determine and/or update an account balance data object associated with a digital asset user account.

As shown in FIG. 1, a digital asset exchange system 106 may be and/or comprise a distributed ledger computing platform comprising a plurality of node computing entities 107 (e.g., 107A, 107B, 107C). For example, in an example embodiment, a digital asset exchange system 106 comprises a plurality of node computing entities 107 in communication with one another via a network 120 and each storing copies of a distributed ledger (e.g., a blockchain) for a digital asset (e.g., a cryptocurrency digital asset). Although not explicitly illustrated, the account management system 102 may be a node computing entity 107 of a digital asset exchange system 106 to enable the execution of the conversion of a cryptocurrency digital asset to other digital assets and/or fiat currency. Each node computing entity 107 may be configured to commit and retrieve portions of the distributed ledger (e.g., distributed ledger entries, records, blocks, and/or the like). A node computing entity 107 may be a full node computing entity that stores the entirety of a distributed ledger (e.g., a blockchain), a mining node computing entity that maintains the distributed ledger (e.g., a blockchain) by publishing updated records, entries, blocks and/or the like while also storing the entirety of the distributed ledger, a lightweight node computing entity that does not store the entirety of the distributed ledger (e.g., a blockchain), and/or the like. Various node computing entities 107 may be configured for providing events, consensus requests, and/or the like; performing consensus processing; storing a copy of a distributed ledger; and/or the like.

Each of the components of the architecture 100 may be in electronic communication with, for example, one another over the same or different wireless or wired networks 120 including, for example, a wired or wireless Personal Area Network (PAN), Local Area Network (LAN), Metropolitan Area Network (MAN), Wide Area Network (WAN), or the like. In some embodiments, the plurality of node computing entities 107 of a digital asset exchange system 106 may be in electronic communication with one another over a different wireless or wired network 120 than the account management system 102 and/or the client device 104. While FIG. 1 illustrates certain systems as separate, standalone entities, the various embodiments are not limited to this particular architecture.

a. Exemplary Account Management System

In an example embodiment, an account management system 102 may be a computing entity configured for managing and executing digital asset conversions (e.g., conversion of a source digital asset to a fiat currency, conversion of a source digital asset to a target digital asset, conversion of a source digital asset to an alternative digital asset) for various end users of a plurality of client devices 104. For the execution of such conversions, an account management system 102 is configured to identify one or more alternative digital assets based at least in part on behavioral data associated with an end user, determine conversion rates for each of a source digital asset, a target digital asset, and/or each alternative digital asset, determine amounts of digital asset units to debit and/or credit during a digital asset conversion, cause debiting of digital asset units, cause crediting of digital asset units, maintain and update account balance data objects associated with user accounts, and/or the like.

The account management system 102 is configured to manage concurrent communications with a plurality of client devices 104 and end users, such as a plurality of requests for digital asset conversions received at substantially the same time. In various embodiments, the account management system 102 stores and/or has access to a plurality of account balance data objects which each indicate a historical account activity of a corresponding user account (e.g., via transaction record data objects each corresponding to an executed conversion). As such, the account management system 102 maintains a record of a plurality of digital asset conversions requested and/or executed and is configured to search and find specific digital asset conversions within the plurality of account balance data objects. Each account balance data object stored by or accessible to the account management system 102 may be associated with a particular digital asset and comprise nested account balance data objects also associated with the same particular digital asset and corresponding to a digital asset user account.

In various embodiments, an account management system 102 may be operated by one or more various entities to manage and execute digital asset conversions for various end users. For example, an account management system 102 may be operated by banking institution entities, digital asset exchange entities, stock exchange entities, trading platform entities, and/or the like. In various embodiments, an account management system 102 may be operated by a single such entity, while in other embodiments, an account management system 102 may host and/or be operated by multiple such entities, each managing digital asset conversions for various client devices 104.

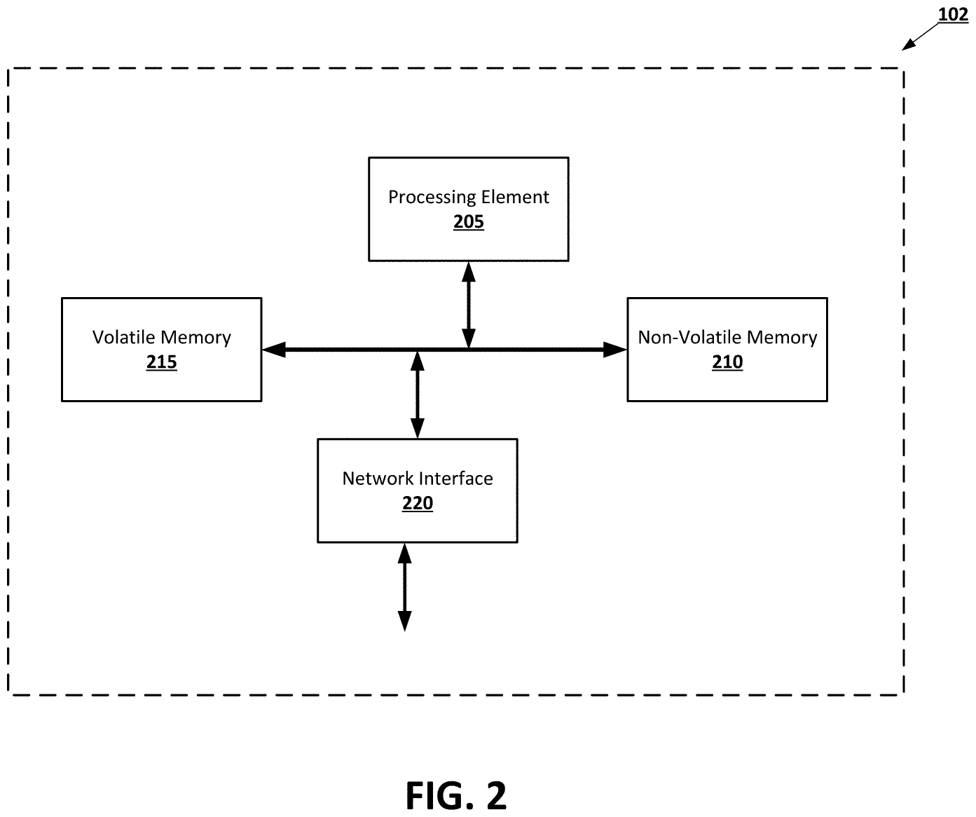

FIG. 2 illustrates a schematic of an example account management system 102, according to one embodiment of the present disclosure. As shown in FIG. 2, in one embodiment, the account management system 102 may include, or be in communication with, one or more processing elements 205 (also referred to as processors, processing circuitry, and/or similar terms used herein interchangeably) that communicate with other elements within the account management system 102 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In one embodiment, the account management system 102 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media 210 may store databases, database instances, database management systems, data, applications, programs, program modules, scripts, source code, object code, byte code, compiled code, interpreted code, machine code, executable instructions, and/or the like. The terms database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the account management system 102 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media 215 may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the step/operation of the account management system 102 with the assistance of the processing element 205 and operating system.

As indicated, in one embodiment, the account management system 102 may also include one or more network interfaces 220 for communicating with various computing entities (e.g., one or more client devices 104, one or more digital asset exchange systems 106), such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the account management system 102 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the account management system 102 may include, or be in communication with, one or more input elements, such as a keyboard input, a mouse input, a touch screen/display input, motion input, movement input, audio input, pointing device input, joystick input, keypad input, and/or the like. The account management system 102 may also include, or be in communication with, one or more output elements (not shown), such as audio output, video output, screen/display output, motion output, movement output, and/or the like.

As will be appreciated, one or more of the components of the account management system 102 may be located remotely from other components of the account management system 102, such as in a distributed system architecture. Furthermore, one or more of the components of the account management system 102 may be combined. Additional components performing functions, operations, methods, processes, and/or the like described herein may be included in the account management system 102. Thus, the account management system 102 may be adapted to accommodate a variety of needs and circumstances.

b. Exemplary Client Device

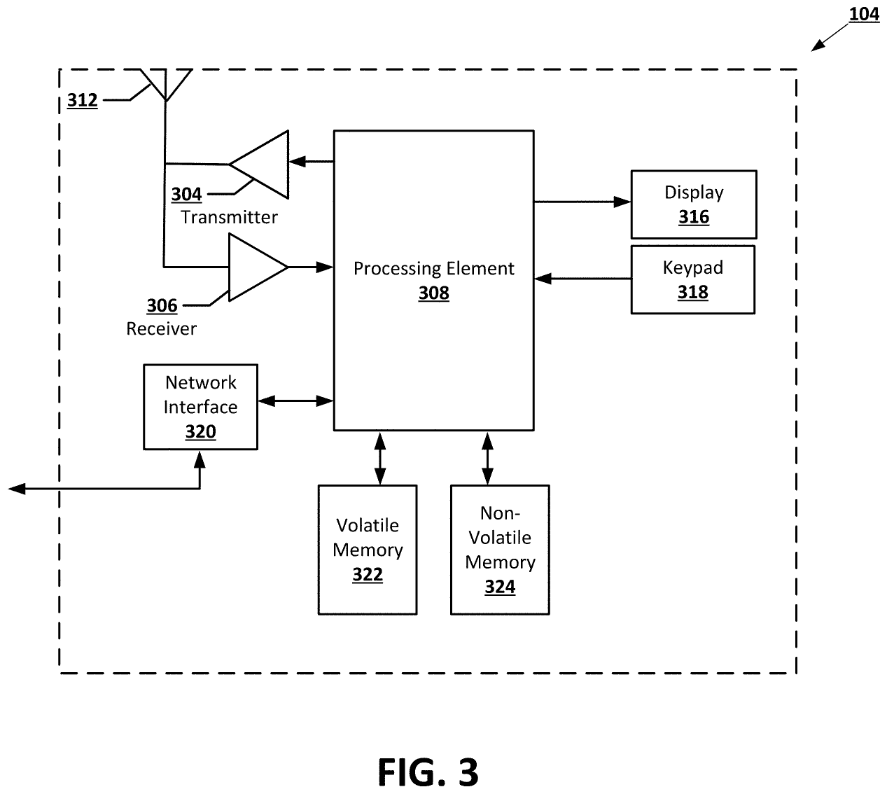

FIG. 3 provides a schematic of an example client device 104 that may be used in conjunction with embodiments of the present disclosure. Client devices 104 can be operated by various entities, and an example architecture 100 may include one or more client devices 104. For example, a client device 104 may be associated with, owned by, operated by, and/or the like by one or more end users. In various instances, an end user of a client device 104 may wish to convert units of a source digital asset to units of a fiat currency or units of a target digital asset and may request or initiate a digital asset conversion using a client device 104. In various embodiments, the end user of a client device 104 is provided with one or more alternative digital asset conversion options each indicating an alternative digital asset via the client device 104. The client device 104 may be configured to receive a selection of an alternative digital asset conversion option (or an alternative digital asset) via user interaction and provide (e.g., transmit) the selection to the account management system 102.

A client device 104 may be a personal computing device, smartphone, tablet, laptop, personal digital assistant, and/or the like. As shown in FIG. 3, the client device 104 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client device 104 may be capable of operating with one or more air interface standards, communication protocols, modulation types, and access types. More particularly, the client device 104 may operate in accordance with any of a number of wireless communication standards and protocols, such as those described above with regard to the account management system 102. In a particular embodiment, the client device 104 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client device 104 may operate in accordance with multiple wired communication standards and protocols, such as those described above with regard to the account management system 102 via a network interface 320.

Via these communication standards and protocols, the client device 104 can communicate with an account management system 102 using concepts, such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client device 104 can also download changes, add-ons, and updates, for instance, to its firmware, software (e.g., including executable instructions, applications, program modules), and operating system.

According to one embodiment, the client device 104 may include location determining aspects, devices, modules, functionalities, and/or similar words used herein interchangeably. For example, the client device 104 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the position of the client device 104 in connection with a variety of other systems, including cellular towers, Wi-Fi access points, and/or the like. Similarly, the client device 104 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client device 104 may also comprise a user interface (that can include a display 316 coupled to a processing element 308) and/or a user input interface (coupled to a processing element 308). For example, the user interface may be a user application, app, browser, user interface, and/or similar words used herein interchangeably executing on and/or accessible via the client device 104 to interact with and/or cause display of information/data from the account management system 102, as described herein. The user input interface can comprise any of a number of devices or interfaces allowing the client device 104 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the client device 104 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client device 104 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client device 104. As indicated, this may include a user application that is resident on the entity or accessible through a browser or other user interface for communicating with the account management system 102.

In another embodiment, the client device 104 may include one or more components or functionality that are the same or similar to those of the account management system 102, as described in greater detail above. As will be recognized, these architectures and descriptions are provided for exemplary purposes only and are not limiting to the various embodiments.

In various embodiments, the client device 104 may be embodied as an artificial intelligence (AI) computing entity, such as an Amazon Echo, Amazon Echo Dot, Amazon Show, Google Home, and/or the like. Accordingly, the client device 104 may be configured to provide and/or receive information/data from an end user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

c. Exemplary Digital Asset Exchange Systems

In various embodiments, an example architecture (e.g., the architecture 100 illustrated in FIG. 1) comprises one or more digital asset exchange systems 106. A digital asset exchange system 106 may be associated with one or more digital assets and may be involved in the debiting and/or crediting of one or more associated digital assets. Accordingly, the architecture 100 may include one or more digital asset exchange systems 106 to thereby enable an end user to convert between a variety of different digital assets. Different digital asset exchange systems 106 may be involved in various embodiments whether an originally requested digital asset conversion is executed or whether an alternative digital asset conversion. For example, a first digital asset exchange system 106A associated with a source digital asset and a second digital asset exchange system 106B associated with a target digital asset may be involved, as well as a third or alternative digital asset exchange system 106C associated with an alternative digital asset, as applicable.

In various embodiments, a digital asset exchange system 106 may be a computing entity configured for engaging with an account management system 102 to debit and/or credit units of a digital asset for an end user. Specifically, a digital asset exchange system 106 may be configured to manage a digital asset user account associated with the end user for a particular digital asset and may be configured to debit, deduct, withdraw, transfer, credit, deposit, and/or the like a number of digital asset units from and/or to the digital asset user account. In various embodiments, the digital asset exchange system 106 may be responsible for transferring fiat currency units to and/or from a fiat currency central operating account associated with the account management system 102 and/or an entity operating the account management system 102 in response to debiting and/or crediting a digital asset user account. For example, the debit of digital asset units by a digital asset exchange system 106 may be part of an exchange of digital asset units for fiat currency, and thus the digital asset exchange system 106 may be responsible for transferring fiat currency units to a fiat currency central operating account associated with the account management system 102. Thus, the digital asset exchange system 106 may be involved at least in part in the debiting and the crediting of digital asset units and/or fiat currency units during the execution of a digital asset conversion, in various embodiments.

Various entities may be associated with and/or operate a digital asset exchange system 106. For example, a digital asset exchange system 106 may be associated with a liability digital asset that may be loyalty or reward points, and the digital asset exchange system 106 may be operated by or associated with a liability holder entity distributing and/or accepting the loyalty or reward points, such as a store entity, a retailer entity, a service provider entity, a banking institution entity, a credit card manager entity, and/or the like. In some instances, a digital asset exchange system 106 associated with a liability digital asset and a liability holder entity may be operated by a third-party entity on behalf of the liability holder entity and/or the liability holder entity itself. Thus, the digital asset exchange system 106 may be and/or comprise one or more computing entities associated with the liability holder entity and may maintain digital asset user accounts (each associated with liability digital assets) for end users corresponding to the liability holder entity. As such, the digital asset exchange system 106 may store and/or have access to records of transactions made by end users with the liability holders that resulted in the assignment or crediting of liability digital asset units to the end users at a previous point in time. Meanwhile, a digital asset exchange system 106 involved in the conversion of cryptocurrency digital assets may be associated with and/or operated by banking institution entities, monetary exchange entities, cryptocurrency exchange entities, stock exchange entities, trading platform entities, and/or the like and may be configured to communicate with and/or may comprise a distributed ledger computing platform. Further, a digital asset exchange system 106 may be associated with and/or operating by an auctioning platform entity, an asset holding entity, and/or the like. For example, such a digital asset exchange system 106 may be involved in the conversion (e.g., sale) of a NFT by an end user.

In various embodiments, a digital asset exchange system 106 may be configured to generate, determine, and/or have access to historical, indicative, current, and/or real-time conversion rates for a digital asset (e.g., with respect to fiat currency, with respect to another digital asset). For example, a digital asset exchange system 106 may be operated by a liability holder entity that may determine a current conversion rate for a liability digital asset based at least in part on supply models, demand models, speculative models, and/or the like. In various embodiments, the digital asset exchange system 106 may comprising a conversion rate application programming interface (API) and may receive conversion rate API queries originating from an account management system 102 at the conversion rate API and to transmit conversion rate API responses comprising historical, indicative, current, and/or real-time conversion rates such that the account management system 102 receives the conversion rates for a digital asset.

In various embodiments, a digital asset exchange system 106 may also publish, broadcast, relay, transmit, and/or the like a generalized conversion rate for a digital asset. For example, a digital asset exchange system 106 may establish that a digital asset generally may be exchanged for a particular (full and/or fractional) number of fiat currency units in general instances and for general end users. The digital asset exchange system 106 may be configured to determine or generate a generalized conversion rate based at least in part on various factors including supply models, demand models, speculative models, and/or the like. In various embodiments, the digital asset exchange system 106 may update the generalized conversion rate and publish, broadcast, relay, transmit, and/or the like a new generalized conversion rate. In various embodiments, the account management system 102 may store a configurable generalized conversion rate for the digital asset exchange system 106, and the digital asset exchange system 106 may modify or update the configurable generalized conversion rate by transmitting an API request to the account management system 102. In various other embodiments, the digital asset exchange system 106 receives an API request or query originating from the account management system 102 asking whether the generalized conversion rate for a digital asset should be used, and the digital asset exchange system 106 may respond with an API response indicating whether the generalized conversion rate should be used and/or including a different exchange rate.

In association with various conversion rates for digital assets, a digital asset exchange system 106 may generate, determine, establish and/or the like configurable rate-specific constraints and configurable conversion conditions. A digital asset exchange system 106 may specify through a configurable rate-specific constraint an amount of digital asset units that may be debited and/or credited at a particular conversion rate (e.g., value worth). For example, a conversion rate may be constrained to indicate that one-hundred digital asset units is worth one fiat currency unit for only up to one-hundred-thousand digital asset units.

Meanwhile, a digital asset exchange system 106 may specify through a configurable conversion conditions and thresholds a total number of digital asset units that may be debited and/or credited for an end user, a cohort of end users, within a configurable time period, and/or the like. For example, a conversion threshold may specify that a maximum of one million digital asset units may be debited from digital asset user accounts for a cohort of end users within a time period of a week. Accordingly, with various configurable rate-specific constraints and configurable conversion conditions, a digital asset exchange system 106 may maintain economic control (or enable an entity to maintain economic control) over a digital asset.

Thus, a digital asset exchange system 106 may comprise various means for performing at least the herein described functions, operations, methods, processes and/or the like. For example, a digital asset exchange system 106 may comprise various processing elements, volatile and/or non-volatile memory or memory media, network interfaces, user interfaces, and/or the like—including those described with regard to the account management systems 102 and/or client devices 104.

d. Exemplary Networks

In one embodiment, any two or more of the illustrative components of the architecture of FIG. 1 (e.g., one or more account management systems 102, one or more client devices 104, one or more digital asset exchange systems 106) may be configured to communicate with one another via respective communicative couplings to one or more networks 120. The networks 120 may include, but are not limited to, any one or a combination of different types of suitable communications networks such as, for example, cable networks, public networks (e.g., the Internet), private networks (e.g., frame-relay networks), wireless networks, cellular networks, telephone networks (e.g., a public switched telephone network), or any other suitable private and/or public networks. Further, the networks 120 may have any suitable communication range associated therewith and may include, for example, global networks (e.g., the Internet), MANs, WANs, LANs, or PANs. In addition, the networks 120 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms provided by network providers or other entities.

### V. EXEMPLARY SYSTEM OPERATION

Various embodiments of the present disclosure include various functions, steps, operations, methods, processes, and/or the like that may (or may be performed to) address technical challenges related to managing digital asset conversions for a plurality of end users and providing alternative digital asset conversion choices for each digital asset conversion. In various embodiments, an originally requested digital asset conversion of a source digital asset to a fiat currency or a target digital asset may be executed, or an alternative digital asset conversion of a source digital asset to an alternative digital asset may instead be executed based at least in part on user selection. Various embodiments thereby provide technical advantages that include the reduction of required user interactions, processing time and resources, and network communication. Such technical advantages are accomplished by preemptively, intelligently, and automatically identifying alternative digital assets for the end user and providing alternative digital asset conversion choices to an end user.

Generally, the steps, operations, methods, processes, and/or the like described herein enable the flexible handling of various different scenarios, which may include execution of an originally requested digital asset conversion or an alternative digital asset conversion. As an exemplary illustrative scenario, an end user requests a digital asset conversion of a source digital asset to a fiat currency and is presented with three alternative digital asset conversion choices. The end user chooses to pursue execution of the originally requested digital asset conversion of the source digital asset to the fiat currency. Accordingly, an amount of source digital asset units is debited from a source digital asset user account and an amount of fiat currency units is credited to a fiat currency user account. As a second exemplary illustrative scenario, an end user requests a digital asset conversion of a source digital asset to a target digital asset and is presented with three alternative digital asset conversion choices. The end user chooses to pursue execution of the originally requested digital asset conversion of the source digital asset to the target digital asset. Accordingly, an amount of source digital asset units is debited from a source digital asset user account and an amount of target digital asset units is credited to a target digital asset user account. As a third exemplary illustrative scenario, an end user requests a digital asset conversion of a source digital asset to a fiat currency and is presented with three alternative digital asset conversion choices. The end user chooses to pursue execution of the second alternative digital asset conversion choice involving a second alternative digital asset. Accordingly, an amount of source digital asset units is debited from a source digital asset user account and an amount of alternative digital asset units is credited to an alternative digital asset user account. Various embodiments may be directed or applied to other various scenarios within the scope of the present disclosure.

a. Exemplary Processes

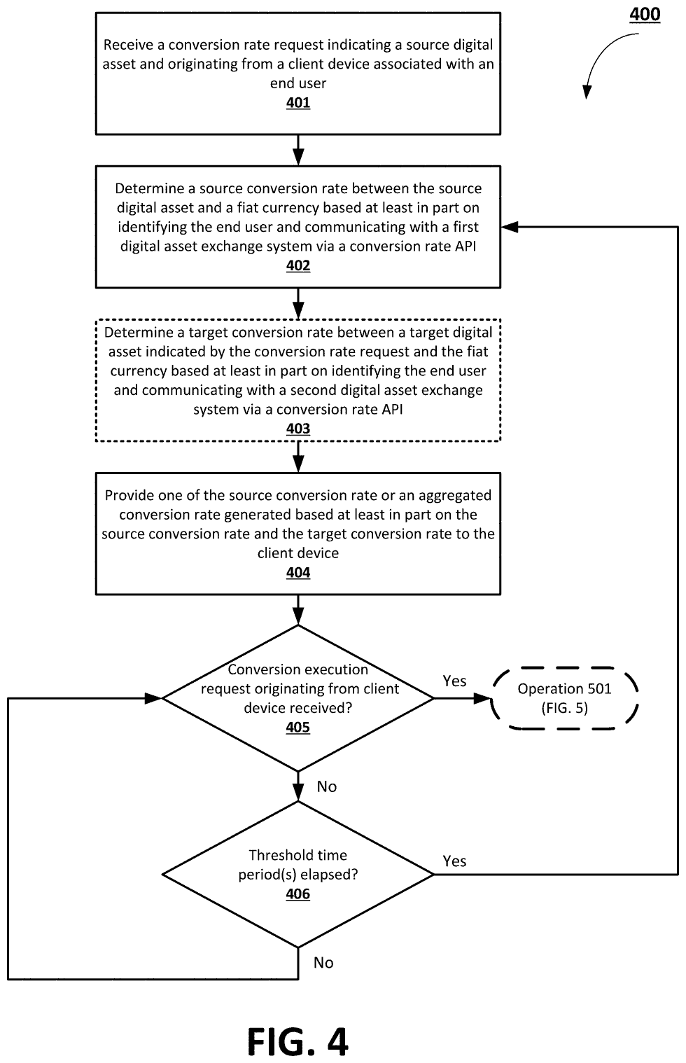

FIG. 4 illustrates a process 400 for initiating a digital asset conversion. In various embodiments, the account management system 102 comprises means, such as processing element 205, memories 210, 215, network interface 220, and/or the like, for performing each of the steps/operations of process 400 to initiate a digital asset conversion. The digital asset conversion initiated via process 400 may be a conversion of a source digital asset to a fiat currency or a conversion of a source digital asset to a target digital asset.

Process 400 comprises step/operation 401. In one embodiment, process 400 begins with and is triggered by step/operation 401. Step/operation 401 comprises receiving a conversion rate request indicating a source digital asset and originating from a client device 104 associated with an end user. For example, the account management system 102 receives a conversion rate request originating from a client device 104 via a network interface 220. In various embodiments, the conversion rate request may be an API call, query, request, and/or the like transmitted by the client device 104. In some instances, the conversion rate request may indicate a target digital asset in addition to the source digital asset, thereby corresponding to a digital asset conversion between a source digital asset and a target digital asset. In other instances, the conversion rate request does not indicate a target digital asset, corresponding to a digital asset conversion of a source digital asset to a fiat currency.

At step/operation 402, a source conversion rate is determined. The source conversion rate is configured to describe the worth of the source digital asset with respect to a fiat currency. For example, the source conversion rate may indicate that one unit of the source digital asset is worth or equal in value to ten fiat currency units (e.g., USD $10). In various embodiments, the source conversion rate is associated with various rate-specific constraints. A rate-specific constraint may limit the source conversion rate to particular amounts or ranges of source digital asset units. An example rate-specific constraint may indicate that one unit of the source digital asset is worth ten fiat currency units (e.g., USD $10) for only up to one hundred units of the source digital asset.

In various embodiments, determining the source conversion rate comprises generating and transmitting a source conversion rate API query to a first digital asset exchange system 106A, which may receive the source conversion rate API query via a conversion rate API. The source conversion rate API query indicates the source digital asset and embodies a request for the first digital asset exchange system 106A to provide a conversion rate for the source digital asset (e.g., a source conversion rate). Thus, the first digital asset exchange system 106A is a digital asset exchange system responsible for and/or managing the source digital asset and configured to generate, determine, and/or provide a source conversion rate. In various embodiments, the account management system 102 is configured to identify a first digital asset exchange system associated with the source digital asset in order to transmit the source conversion rate API query to the first digital asset exchange system.

In various embodiments, the source conversion rate API query comprises an identifier token associated with the end user and configured to uniquely identify the end user for the first digital asset exchange system 106A and/or to identify a source digital asset user account associated with the end user and specific to the source digital asset. For example, the identifier token may comprise names of the end user, a birthdate, Social Security number, contact information (e.g., an e-mail address, a phone number) and/or other personal identifying information. The identifier token may additionally or alternatively comprise various account identifiers for the source digital asset user account. In some instances, the identifier token may comprise a distributed ledger public key value and/or a cryptocurrency address in order to identify the source digital asset user account for a cryptocurrency exchanged via a distributed ledger. In various embodiments, the identifier token may be and/or may comprise a GUID, a UIUD, a hash or cryptographic value of user information or credentials, and/or the like. Thus, the identifier token may be configured to cause the first digital asset exchange system 106A to identify a source digital asset user account specific to the source digital asset. The identifier token may be established based at least in part on single sign-on (SSO) authentication techniques and/or methods. As such, various embodiments of the present disclosure provide technical advantages by enabling an end user to request conversions of source digital asset units of a source digital asset user account via an account management system 102 that may not necessarily manage or be in custody of the source digital asset user account.

In various embodiments, the source conversion rate API query comprises a conversion behavior analytics data object. The conversion behavior analytics data object is configured to describe behavioral data associated with the end user and/or a cohort including the end user. The conversion behavior analytics data object is generated based at least in part on determining one or more conversion behavior cohorts including the end user. One or more cohorts may be determined based at least in part on demographic information and/or other information associated with the end user. For example, the account management system 102 may determine a cohort based at least in part on the age of the end user, based at least in part on the gender of the end user, based at least in part on the residence of the end user, and/or the like. A cohort may also be determined based at least in part on account information, status, activity history, and/or the like of one or more digital asset user accounts and/or a fiat currency user account associated with the end user. In some instances, various digital asset user accounts associated with various different end users may be associated or assigned with different statuses, levels, tiers, and/or the like by a digital asset exchange system managing the various digital asset user accounts, such statuses being based at least in part on various factors such as history, a number of purchases made (e.g., loyalty), membership fees, and/or the like. Accordingly, a cohort may be composed of other end users with digital asset user accounts with the same status, level, tier, and/or the like as the end user. Similarly, a cohort may be composed of end users who have not converted, transacted, redeemed, and/or the like a digital asset, while another cohort may be composed of end users who frequently convert, transact, redeem, and/or the like the digital asset. Overall, it will be understood that cohorts for an end user may be determined based at least in part on various different criteria, and that one or more cohorts may be determined for the end user. Such criteria for determining one or more cohorts for the end user may be retrieved from account balance data objects corresponding to user accounts associated with the end user. For example, an account balance data object may describe a status, level, tier, and/or the like of a corresponding user account and may also describe the activity history of the corresponding user account. As such, the account management system 102 may store, retrieve, and/or have access to various account balance data objects for determining one or more cohorts for the end user.

The conversion behavior analytics data object then describes behavioral data associated with the end user and/or each end user of a cohort including the end user. In various embodiments, the behavioral data may be specific to a digital asset (e.g., the source digital asset, the target digital asset, an alternative digital asset). For example, the conversion behavior analytics data object may describe a number of times an end user and/or a cohort of end users redeemed a digital asset (e.g., for services, for physical goods, for fiat currency, for other digital assets), various conversion rates at which a digital asset was used, and/or the like. In various embodiments, the conversion behavior analytics data object may at least indicate and/or suggest conversion rates at which the end user and/or a conversion behavior cohort of the end user have historically used a digital asset.

In various embodiments, the conversion behavior analytics data object may comprise predictive indications related to the usage of a digital asset, such as a probability of whether the end user would convert the digital asset for a fiat currency at a particular conversion rate, for example. As such, the conversion behavior analytics data object may be generated based at least in part on various predictive models, optimization models, classification models, neural network models, supervised or unsupervised machine learning models, and/or the like configured to output predictions and/or probabilities as to whether a particular conversion rate would be acceptable to and/or lead to usage of the digital asset by the end user and/or a conversion behavior cohort of the end user. Thus, in general, a conversion behavior analytics data object is transmitted with the source conversion rate API query and is configured to be used (e.g., by the first digital asset exchange system 106A) in determining a conversion rate for the source digital asset.

In general, the source conversion rate API query may be configured to cause the first digital asset exchange system 106A to generate, determine, and/or provide a conversion rate for the source digital asset with respect to fiat currency. In various embodiments, the source conversion rate API query may indicate one or more fiat currencies and is configured to cause the first digital asset exchange system 106A to provide a conversion rate between the source digital asset and each indicated fiat currency. For example, the end user selects a fiat currency to receive in the digital asset conversion, and the source conversion rate API query indicates the selected fiat currency. As another example, the source conversion rate API query indicates a fiat currency based at least in part on stored data in an account balance data object describing a preferred or default fiat currency. As yet another example, the source conversion rate API query indicates a fiat currency based at least in part on the real-time determination or approximation of the end user's location (e.g., via global positioning circuitry of the client device 104).

In various embodiments, the source conversion rate API query may also comprise a request for historical conversion rates. For example, a source conversion rate API query indicating a cryptocurrency digital asset as the source digital asset may be configured to cause the first digital asset exchange system 106A to provide historical conversion rates for the cryptocurrency digital asset with respect to fiat currency over a configurable past time period.

Determining the source conversion rate then comprises receiving a source conversion rate API response originating from the first digital asset exchange system 106A. The source conversion rate API response comprises a conversion rate between the source digital asset and the fiat currency. The source conversion rate API response may additionally comprise historical and indicative conversion rates for the source digital asset. In various embodiments, the source conversion rate API response is a response to the source conversion rate API query and is therefore generated based at least in part on the source conversion rate API query. For example, the source conversion rate API response may comprise one or more conversion rates between the source digital asset and one or more fiat currencies indicated by the source conversion rate API query (e.g., a first conversion rate indicating the value of the source digital asset with respect to US dollars, and a second conversion rate indicating the value of the source digital asset with respect to EU euros).

In various embodiments, the source conversion rate API response comprises additional data associated with the source conversion rate, such as execution time periods. An execution time period may indicate a period of time within which the conversion rate for the source digital asset is valid. For example, the first digital asset exchange system 106A will engage in a conversion involving the source digital asset based at least in part on the provided source conversion rate only within the execution time period.

Additional data included with the source conversion rate API response may include various rate-specific constraints that may affect conversions involving the source digital asset. A rate-specific constraint may limit an amount of source digital asset units that may be debited during a digital asset conversion. For example, a rate-specific constraint may indicate that up to 100,000 source digital asset units (or any other range or band of units) may be converted to fiat currency at the provided conversion rate. Similarly, the source conversion rate API response may include one or more conversion rates each with corresponding rate-specific constraints. As an example, the source conversion rate API response may indicate that one unit of a liability digital asset may be converted to USD $5, two units may be converted to USD $7, and five units may be converted to USD $15. Thus, in some embodiments, conversion rates may be subject to discrete rate-specific constraints, indicated via the source conversion rate API response.

The source conversion rate API response may additionally comprise an account balance data object corresponding to the source digital asset user account for the source digital asset. In various embodiments, the source conversion rate API response is configured to cause the account management system 102 to generate and/or update an account balance data object corresponding to the source digital asset user account in memory 210, 215 of the account management system 102. As such, the account management system 102 may be aware of the current source digital asset unit balance of the source digital asset user account upon receiving the source exchange rate API response, in some embodiments.

In some instances, the conversion rate provided via the source conversion rate API response is a generalized conversion rate that applies to all end users. For example, the source digital asset is a cryptocurrency with a conversion rate universally applied to all end users. Thus, in some instances, the source exchange rate API response indicates that a previously published, stored, broadcasted, and/or the like source conversion rate should be used for the conversion. In some embodiments, the source exchange rate API response comprises instructions to modify a previously determined generalized exchange rate.

In other instances, however, the source conversion rate may be specific to the end user and/or a cohort including the end user. For example, a favorable conversion rate (e.g., high return rate of fiat currency, high value of source digital asset with respect to fiat currency) may be provided only to a particular cohort of end users. A first conversion rate for the source digital asset may be provided to end users who have used the source digital asset (e.g., in digital asset conversions, in transactions for exclusive goods and services) more than a configurable threshold number of times within a configurable time period (e.g., the past week, the past month, the past year), while a second conversion rate for the source digital asset may be provided to end users who have used the source digital asset less than the threshold number of times within the configurable time period. In generating a conversion rate to provide via the source conversion rate API response then, the first digital asset exchange system 106A may train and use various models to determine (e.g., based at least in part on extrapolation, regression, prediction, and/or the like) a conversion rate for the source digital asset based at least in part on dynamic user activity or behavior of the end user. The conversion rate for the source digital asset may also be predictively determined (e.g., by the first digital asset exchange system 106A) based at least in part on behavioral data associated with the end user and/or with a cohort including the end user. In some examples, the first digital asset exchange system 106A uses various predictive models, optimization models, machine learning models, and/or the like to determine a conversion rate for the source digital asset predicted to cause the end user to request a digital asset conversion involving the source digital asset.

Accordingly, the first digital asset exchange system 106A may train various models (e.g., in a supervised manner, semi-supervised manner, and/or unsupervised manner) using behavioral data associated with the end user and/or a cohort including the end user. Such behavioral data for example may describe whether or not the end user and/or a cohort has historically converted the source digital asset for fiat currency for a particular conversion rate. The first digital asset exchange system 106A may then use the various trained models to determine a conversion rate for the source digital asset likely to be accepted by the end user. For example, the first digital asset exchange system 106A may determine that the end user is significantly more likely to convert the source digital asset with a first conversion rate where one source digital asset unit is worth USD $20 than with a second conversion rate where one source digital asset unit is worth USD $5. In various embodiments, the first digital asset exchange system 106A may train and use various predictive models, optimization models, machine learning models, and/or the like to predict an optimized conversion rate (e.g., lowest number of fiat currency units for one source digital asset unit, highest number of source digital asset units for one fiat currency unit) for the end user. Thus, in various embodiments, various predictive models, optimization models, machine learning models, and/or the like may be trained to generate (e.g., output) a conversion rate likely to cause the end user to convert units of the source digital asset.

In instances when the conversion rate request additionally indicates a target digital asset and the end user requests a digital asset conversion of a source digital asset to a target digital asset, step/operation 403 may be performed. Step/operation 403 comprises determining a target conversion rate, which describes the worth of the target digital asset with respect to a fiat currency. The determination of a target conversion rate may be similar to the determination of the source conversion rate, as discussed above. Determining a target conversion rate comprises generating and transmitting a target conversion rate API query to a second digital asset exchange system 106B associated with the target digital asset and receiving a target conversion rate API response comprising the target conversion rate and originating from the second digital asset exchange system 106B. Similar to the source conversion rate, the target conversion rate may be dynamic and/or predictive. For example, the second digital asset exchange system 106B may generate a target conversion rate using various predictive models, optimization models, machine learning models, and/or the like to dynamically determine a target conversion rate based at least in part on behavioral data associated with the end user and/or a cohort including the end user.

In various embodiments, the target conversion rate API query comprises an identifier token associated with the end user and configured to uniquely identify the end user for the second digital asset exchange system 106B and/or to identify a second digital asset user account associated with the end user and specific to the target digital asset. The identifier token of the target conversion rate API query may be the same identifier token transmitted with the source conversion rate API query. That is, in various embodiments, one identifier token is associated with the end user and is federated for various different digital asset exchange systems 106. For example, the same identifier token associated with the end user may be used to identify the source digital asset user account for the source digital asset and managed by a first digital asset exchange system 106A, as well as to identify a second digital asset user account for the target digital asset and managed by a second digital asset exchange system 106B. Thus, the identifier token may be established based at least in part on SSO authentication techniques and/or methods for different digital asset exchange systems 106. It will be appreciated then that additional technical advantages are provided here by reducing, compressing, minimizing, and/or the like the amount of data needed to identify an end user for various different digital asset exchange systems 106. In various embodiments, the account management system 102 is configured to provide the identifier token associated with the end user to a particular digital asset exchange system 106 to identify a particular digital asset user account without compromising the authentication, credentials, identifiers, and/or the like for other digital asset user accounts managed by other digital asset exchange systems 106. For example, a first digital asset exchange system 106A receiving the identifier token (e.g., with the source exchange rate API query) may be barred, precluded, prevented, and/or the like from accessing information related to a second digital asset user account for the target digital asset and managed by a second digital asset exchange system 106B.

The target conversion rate API query may also comprise a conversion behavior analytics data object configured to describe behavioral data associated with the end user and/or a cohort including the end user and to be used by the second digital asset exchange system 106B in generating the target conversion rate. The target conversion rate API response may comprise various rate-specific constraints and time periods associated with the target conversion rate, such as the same associated with the source conversion rate in the source conversion rate API response.

In various embodiments, the target conversion rate API query and the source conversion rate API query may be generated and transmitted substantially simultaneously or in parallel, such that the conversion rate for the source digital asset and the conversion rate for the target digital asset may be obtained at substantially the same time. In various other embodiments, the target conversion rate API query may be generated and transmitted subsequent to determining the source conversion rate. Specifically, the target conversion rate API query may be based at least in part on the source conversion rate and/or various rate-specific constraints for the source conversion rate. For example, rate-specific constraints for the source conversion rate may indicate that only a maximum of one-hundred-thousand reward points digital assets may be converted to a maximum for USD $100, and thus, the target conversion rate API query may specifically request a target conversion rate describing the amount of target digital asset units that may be obtained for USD $100. As another example, the received source exchange rate API response may indicate one or more discrete fiat currency unit numbers (e.g., USD $5, USD $10, and USD $20) that may be obtained for converting the source digital asset, and then the target exchange rate API query may request target conversion rates describing the number of target digital asset units that may be obtained for each discrete fiat currency unit number (e.g., twenty-five target digital asset units for USD $5, forty-five target digital asset units for USD $10, seventy-five target digital asset units for USD $20). Thus, in some embodiments, the target conversion rate API query may be dependent on the source conversion rate and constraints thereof.

Step/operation 404 comprises providing the source conversion rate or a first aggregated conversion rate to the client device 104, or to the end user via the client device 104. In instances where the requested digital asset conversion is between the source digital asset and the fiat currency, the source conversion rate is provided to the end user. The source conversion rate is provided to indicate to the end user an amount of fiat currency units that may be received for the conversion of an amount of source digital asset units.

In other instances where the requested digital asset conversion is between the source digital asset and the target digital asset, an aggregated conversion rate is generated and provided to the end user. An aggregated conversion rate is configured to describe the worth of the source digital asset with respect to the target digital asset and may be generated based at least in part on the source conversion rate and the target conversion rate (each with respect to fiat currency). The aggregated conversion rate may be determined such that the aggregated conversion rate satisfies rate-specific constraints for both the source conversion rate and the target conversion rate. As such, the aggregated conversion rate may be determined using an optimization model configured to evaluate multiple rate-specific constraints and to generate an output satisfying the plurality of constraints.

For example, in an example scenario, a liability holder entity managing the source digital asset may indicate that up to fifteen-thousand reward points may be converted to USD $150, while an entity managing the target digital asset may indicate that only up to five-hundred in-game assets may be exchanged (e.g., purchased) for USD $100. Due to the rate-specific constraint with respect to the target digital asset, the account management system 102 may use an optimization model to generate an aggregated conversion rate of ten-thousand reward points for five-hundred in-game assets. In many instances, there may be more than one rate-specific constraint, and the optimization model generates an aggregated conversion rate satisfying each and every rate-specific constraint. In some instances, the conversion rates and associated rate-specific constraints may be structured as discrete values. For example, it may be indicated that fifty in-game assets may be purchased for USD $10, one-hundred in-game assets may be purchased for USD $25, two-hundred in-game assets may be purchased for USD $25; however, such conversion rates may not be interpolated or extrapolated to purchase fifty-seven in-game assets, for example. Thus, the aggregated conversion rate may be determined based at least in part on such discrete values.

In various embodiments, the source conversion rate or the aggregated conversion rate is provided in an API response to a conversion rate request originating from the client device 104 (e.g., in step/operation 401). In various embodiments, the aggregated conversion rate may be provided with instructions causing the client device 104 to provide the aggregated conversion rate to the end user. For example, the client device 104 may be caused to provide the aggregated conversion rate in a notification to the end user. As another example, the client device 104 may display the aggregated conversion rate to the end user via a user interface. The aggregated conversion rate may be provided to the end user via the client device 104 from a source digital asset perspective (e.g., an amount of target digital asset units equal in value to one source digital asset unit) and/or from a target digital asset perspective (e.g., an amount of source digital asset units equal in value to target digital asset unit). In some instances, one or more aggregated conversion rates based at least in part on discrete rate-specific thresholds or limits may be presented to the end user. For example, it may be indicated to the end user via the client device 104 that one-hundred reward points may be converted to five in-game assets, two-hundred reward points may be converted to eight in-game assets, and two-hundred-and-fifty reward points may be converted to twelve in-game assets.

At step/operation 405, the account management system 102 determines whether a conversion execution request originating from the client device 104 has been received. In various embodiments, the conversion execution request may be transmitted by the client device 104 based at least in part on user interaction, or user input. The conversion execution request may indicate the end user's approval of the source conversion rate in instances of a conversion of the source digital asset to the fiat currency, or the end user's approval of the aggregated conversion rate in instances of a conversion of the source digital asset to the target digital asset. In various embodiments, the conversion execution request may indicate a specified amount of source digital asset units to debit or spend in the digital asset conversion (e.g., for some amount of fiat currency units, for some amount of target digital asset units). The specific amount of source digital asset units in various instances is configured by the end user of the client device 104. In some embodiments, the conversion execution request may additionally indicate a specified amount of fiat currency units or a specified amount of target digital asset units. Similarly, such specified amounts (e.g., of fiat currency units, of target digital asset units) may have been configured by the end user of the client device 104. In various embodiments, the account management system 102 is configured to determine at least one of an amount of source digital asset units, an amount of fiat currency units, or an amount of target digital asset units for a digital asset conversion based at least in part on the source conversion rate or the aggregated conversion rate.

If the account management system 102 determines that a conversion execution request originating from the client device 104 has not been received, step/operation 406 is performed. At step/operation 406, the account management system 102 determines whether one or more configurable threshold time periods have elapsed or expired. In various embodiments, the one or more configurable threshold time periods may represent a time period within the source conversion rate or the aggregated conversion rate provided to the client device is accurate and/or valid for the execution of a conversion. For example, the one or more configurable threshold time periods may comprise a configurable refresh time period representing a temporal resolution at which the conversion rate for the source digital asset and the conversion rate for the target digital asset may vary. That is, the worth of the source digital asset and/or the target digital asset may be volatile and may only be accurate and representative for a limited time period (e.g., the configurable refresh time period). In various embodiments, the refresh time period may be configured to be thirty, sixty, ninety, and/or the like second time periods.

Likewise, the one or more configurable threshold time periods may comprise a configurable execution time period representing a time period within which a digital asset conversion may be executed. For example, a digital asset exchange system 106 may indicate (e.g., in a source exchange rate API response, in a target exchange rate API response) a time period for which various conversion rates are valid and/or for which debiting and crediting of digital asset units may be completed. It may be appreciated that for a digital asset with volatile value (e.g., a cryptocurrency), a configurable execution time period may be longer in duration than a configurable refresh time period, such that conversions, exchanges, and other transactions with such volatile digital assets are executed based at least in part on a previously agreed-upon conversion rate. In various embodiments, the execution time period may be configured to one, two, five, ten, twenty, and/or the like minute time periods. Such configurable time periods may be configured and established by various digital asset exchange systems 106, such as in the previously described example, and/or may be configured and established by the account management system 102.

Accordingly, if the account management system 102 determines that one or more configurable time periods (e.g., a refresh time period, an execution time period) have elapsed, the account management system 102 may determine a new conversion rate for the source digital asset (and the target digital asset if applicable). For example, the account management system 102 may perform at least steps/operations 402, 403, 404, 405 and 406 repeatedly and periodically to determine and provide current and real-time conversion rates. Otherwise, as illustrated in FIG. 4B, the account management system 102 again determines whether a conversion execution request originating from the client device 104 has been received, at step/operation 405.

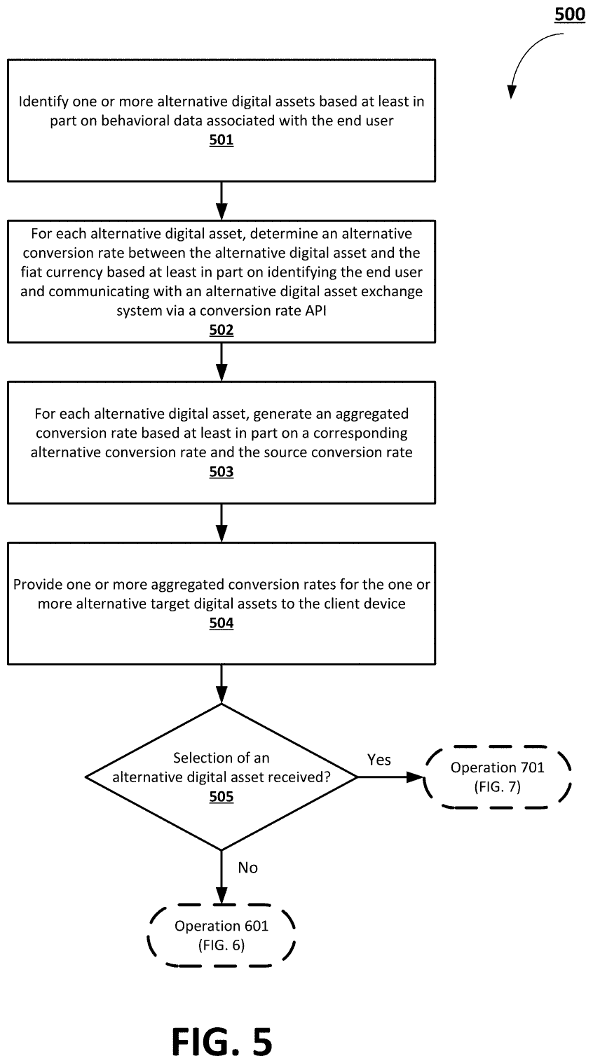

However, if the conversion execution request is received at step/operation 405, the account management system 102 may continue to initiate and execute a digital asset conversion. Referring now to FIG. 5, a process 500 is illustrated. In various embodiments, the account management system 102 comprises means, such as processing element 205, memories 210, 215, network interface 220, and/or the like, for performing each of the steps/operations of process 500. As shown, process 500 comprises and may begin with step/operation 501. Specifically, step/operation 501 may be performed subsequent to and/or responsive to determining that a conversion execution request was received in step/operation 405, in some embodiments.

Step/operation 501 comprises identifying one or more alternative digital assets based at least in part on behavioral data associated with the end user. As such, the account management system 102 may identify the one or more alternative digital asset using the identifier token for the end user and/or a conversion behavior analytics data object for the end user and/or a cohort including the end user. In various embodiments, the account management system 102 trains and uses various predictive and/or machine learning models to identify one or more alternative digital assets predicted to be of interest to the end user. Such models may be trained on behavioral data, such as data describing digital assets previously involved in digital asset conversions requested by the end user, and may receive such behavioral data as input when identifying one or more alternative digital assets. The one or more alternative digital assets may be identified based at least in part on embeddings, probabilities, weights, and/or the like output by the various models. In some embodiments, the account management system 102 selects three alternative digital assets from a plurality of alternative digital assets, the three alternative digital assets associated with high probabilities of being of interest to the end user.

In various embodiments, the account management system 102 is configured to communicate with multiple digital asset exchange systems 106 to identify one or more alternative digital assets available to be credited to the end user. The account management system 102 transmits to each digital asset exchange system 106 information including information identifying the end user (e.g., an identifier token) and information regarding the originally requested conversion to determine whether a digital asset exchange system 106 (or an entity associated with the digital asset exchange system 106) is interested in becoming involved in an alternative conversion with the end user. Specifically, the account management system 102 provides at least an amount of fiat currency units that would be credited to the end user or that would be used to credit target digital asset units to the end user in the originally requested conversion. The account management system 102 may be configured to provide such information and request indications of available alternative digital assets via a broadcast or a transmission generally transmitted to a plurality of digital asset exchange systems 106. A digital asset exchange system 106 may then respond in some instances offering an alternative digital asset to credit to the end user as an alternative to crediting fiat currency units or target digital asset units to the end user. Any particular digital asset exchange system 106 (and/or an associated entity) may be motivated to do so to obtain a new customer or increase customer activity with the alternative digital asset managed and distributed by the associated entity.

Accordingly, in various embodiments, one or more alternative digital assets are identified based at least in part on communicating and providing information to a plurality of digital asset exchange systems 106, a subset of which responding with indications or requests to offer an alternative digital asset to the end user as an alternative to fiat currency or the target digital asset in the originally requested conversion. In some instances, a large volume of available alternative digital assets are offered during such communications with the plurality of digital asset exchange systems 106 in bidding to be involved in an alternative conversion for the end user, and the account management system 102 is configured to select one or more alternative digital assets. For example, the account management system 102 selects three alternative digital assets from a volume of available alternative digital assets.

Step/operation 502 comprises determining a conversion rate for each identified (e.g., selected) alternative digital asset. Each alternative conversion rate describes the worth of a corresponding alternative digital asset with respect to the fiat currency. Similar to the determination of conversion rates for the source digital asset and the target digital asset, if applicable, determination of alternative conversion rates may comprise generating and transmitting an alternative conversion rate API query to alternative digital asset exchange systems responsible for and/or managing the identified alternative digital assets. Similarly, an alternative conversion rate API query comprises an identifier token identifying the end user for the alternative digital asset exchange system and a conversion behavior analytics data object that may be used by the alternative digital asset exchange system in generating a conversion rate for the alternative digital asset. The identifier token may the same federated identifier token used in determining the source conversion rate and the target conversion rate. Determination of alternative conversion rates may then comprise receiving alternative conversion rate API responses originating from alternative digital asset exchange systems and comprising conversion rates for alternative digital assets.

Similar to the conversion rates for each of the source digital asset and the target digital asset, a conversion rate for an alternative digital asset may be individualized and predictive. A conversion rate for an alternative digital asset may be generated by an alternative digital asset exchange system 106C specifically for the end user and/or a cohort including the end user. Accordingly, the conversion rate for an alternative digital asset may be generated by an alternative digital asset exchange system 106C using various predictive and/or machine learning models, the identifier token, and/or the conversion behavior analytics data object of the alternative conversion rate API query.

In some embodiments, the status of a digital asset as an alternative digital asset may affect its conversion rate. An entity managing an alternative digital asset may be motivated to generate a favorable conversion rate to encourage the end user to abandon the originally requested conversion of the source digital asset to the fiat currency or the target digital asset and to instead convert the source digital asset to the alternative digital asset. Accordingly, the alternative digital asset exchange system 106C may be informed (e.g., via the alternative conversion rate API query) of the source conversion rate and/or a target conversion rate. The alternative digital asset exchange system 106C may then generate a competing and favorable conversion rate for the alternative digital asset.

At step/operation 503, aggregated conversion rates are generated for each alternative digital asset. The aggregated conversion rate for each alternative digital asset describes the worth of the source digital asset with respect to a corresponding alternative digital asset. Thus, the aggregated conversion rate for an alternative digital asset may describe the relationship in worth between the source digital asset and the alternative digital asset. Similar to the aggregated conversion rate for the target digital asset, the aggregated conversion rate for an alternative digital asset is generated based at least in part the source conversion rate, the conversion rate for the alternative digital asset, and various rate-specific constraints of each. In some embodiments, the aggregated conversion rate is generated using optimization models to generate an aggregated conversion rate satisfying the various rate-specific constraints.

At step/operation 504, one or more aggregated conversion rates for the one or more alternative digital assets are then provided to the client device 104, or to the end user via the client device 104. In various embodiments, the one or more aggregated conversion rates are provided to the end user by presenting one or more alternative digital asset conversion choices. Each alternative digital asset conversion choice may be a data entity describing an alternative digital asset, an aggregated conversion rate, various rate-specific constraints, various conversion conditions, and/or the like. In various embodiments, the one or more alternative digital asset conversion choices are presented via a notification or an alert to the end user. In some embodiments, the notification presented alternative digital asset conversion choices is configured to cause the end user to actively make a selection of an alternative digital asset conversion choice or the originally requested conversion. For example, the notification may obstruct or disable interface mechanisms that trigger the execution of the originally requested conversion.

With presenting the alternative digital asset conversion choices with aggregated conversion rates to the end user, various technical advantages are provided. By automatically determining and providing aggregated conversion rates, the end user is presented with accurate, current, and complete information. User interactions, processing time, and networking resources are reduced, as the need for the end user to manually and individually select different digital assets and request conversion rate requests is precluded. That is, comprehensive and intelligently selected alternative choices are automatically presented to the end user, along with accurate and complete information.

The alternative digital asset conversion choices are presented to the end user via a user interface including interactable mechanisms via which an end user may select a particular alternative digital asset conversion choice. In various embodiments, an end user may select a particular alternative digital asset conversion choice to indicate that the end user would like to convert the source digital asset to the corresponding alternative digital asset, instead of to the originally requested fiat currency or target digital asset. Accordingly, step/operation 505 comprises determining whether a selection of an alternative digital asset was received originating from the client device 104.

In instances when a selection of an alternative digital asset is not received, an indication of the originally requested conversion (e.g., the source digital asset to the fiat currency, the source digital asset to the target digital asset) may be received. That is, in some embodiments, the end user explicitly declines the alternative digital asset conversion choices and indicates to continue with the originally requested conversion. Accordingly, if an alternative digital asset is not selected, the account management system 102 executes the originally requested digital asset conversion.

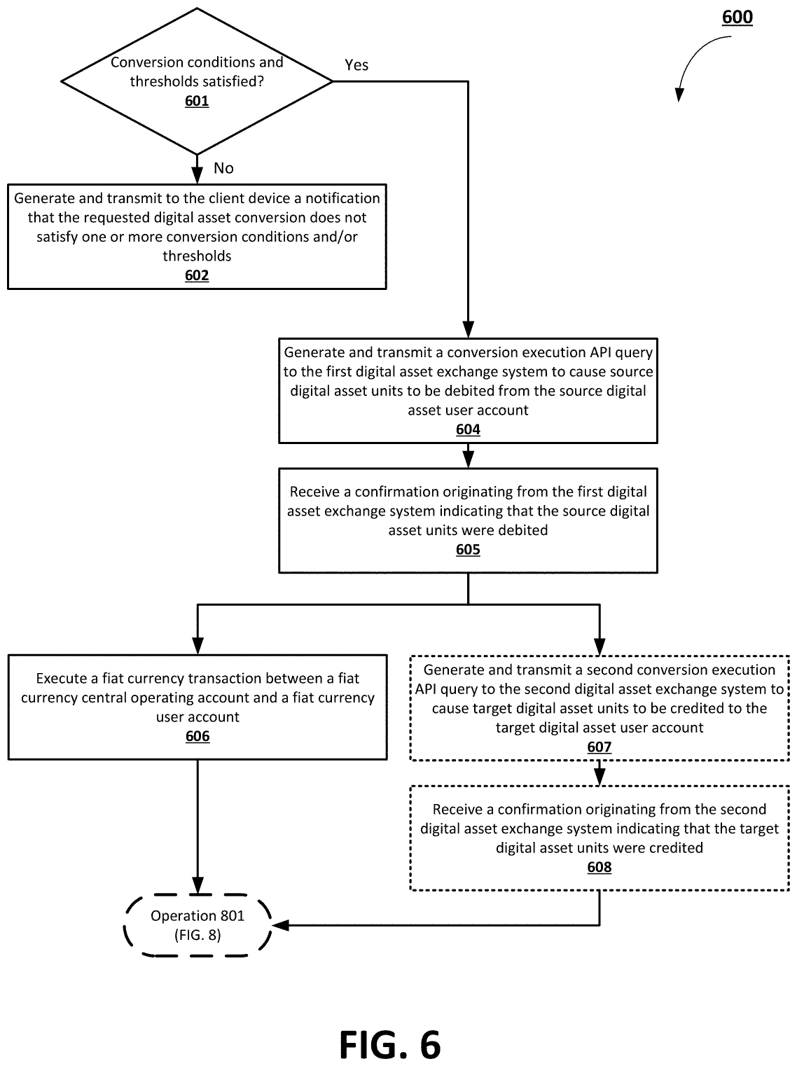

FIG. 6 illustrates a process 600 for executing the originally requested digital asset conversion. As previously mentioned, the originally requested digital asset conversion may be a conversion of the source digital asset to the fiat currency or may be a conversion of the source digital asset to the target digital asset. In various embodiments, the account management system 102 comprises means, such as processing element 205, memories 210, 215, network interface 220, and/or the like, for performing each of the steps/operations of process 600 to execute a digital asset conversion.

At step/operation 601, various conversion conditions and thresholds are evaluated, and the account management system 102 determines whether the originally requested digital asset conversion satisfies the various conversion conditions and thresholds. In various embodiments, the various conversion conditions and thresholds comprise a condition that the end user has a sufficient unit balance in the source digital asset user account. Thus, in various embodiments, the amount of source digital asset units to debit in the originally requested digital asset conversion is determined. This amount may be specified in the conversion execution request originating from the client device 104 (e.g., in step/operation 405). Alternatively, an amount of fiat currency units or an amount of target digital asset units is specified in the conversion execution request, and the amount of source digital asset units is determined using the source conversion rate or the aggregated conversion rate. The amount of source digital asset units to debit in the originally requested digital asset conversion is then compared to the unit balance of the source digital asset user account. For example, an account balance data object may be retrieved, received, processed, and/or the like for the unit balance of the source digital asset user account.

The various conditions and thresholds may additionally or alternatively include time periods within which digital asset conversions are executed. For example, the account management system 102 may establish trading or operating hours only within which conversion execution requests are processed. This may advantageously control and manage computing and processing resources for the account management system 102, and conversion execution requests received outside of such trading or operating hours may be added to a queue for later processing. Similarly, a digital asset exchange system 106 may establish or configure time periods within which digital asset units may be debited or credited. Thus, at step/operation 601, the account management system 102 determines whether the originally requested digital asset conversion can be executed at the current time.

In various embodiments, the conversion conditions and thresholds include various configurable limits established by one or more digital asset exchange systems 106. In particular, such configurable limits are established to manage and/or maintain the value or economy of a corresponding digital asset (e.g., the source digital asset, the target digital asset). For example, the first digital asset exchange system 106A may establish and configure a conversion threshold preventing an end user from redeeming over a threshold number of source digital asset units. In various embodiments, a digital asset exchange system 106 may establish and configure a cohort-based limit preventing a cohort of end users from converting a total number of digital asset units. For example, the second digital asset exchange system 106B may establish and configure a limit preventing a cohort of end users from obtaining over a threshold number of target digital asset units. In other instances, a conversion threshold is a threshold number of digital asset conversions (or individual exchanges of a digital asset with fiat currency) that may be executed within a configurable time period. In various embodiments, the account management system 102 may also establish various limits (e.g., for compliance with various rules and regulations). For example, the account management system 102 may limit the number of conversions that may be executed within a time period. Various other limits may be configured to monitor or detect fraudulent transactions. For example, the account management system 102 may limit the number of conversions executed for a specific end user within a specific time period.

The conversion conditions and thresholds further include large-scale economic analysis to detect situations involving a “run on points”. Such situations involve a large number of end users requested digital asset conversions with large amounts of units. If a significant amount of source digital asset units is debited within a short time frame, for example, the value of the source digital asset may be intentionally or inadvertently drastically changed. As such, the account management system 102 may determine a total amount of source digital asset units debited over the current time period (including in the originally requested digital asset conversion) and evaluate whether the total amount of source digital asset units satisfies a threshold. Similarly, the account management system 102 may determine a total amount of target digital asset units credited over a current time period (including in the originally requested digital asset conversion) and perform a similar evaluation. In some embodiments, the account management system 102 trains and uses various predictive models, optimization models, machine learning models, and/or the like to determine whether a significant change in unit supply or distribution of the source digital asset and/or the target digital asset is likely based at least in part on the originally requested digital asset conversion. That is, the account management system 102 may determine whether a “run on points” may occur where large quantities of digital asset units are being credited or debited, dramatically changing the digital asset unit distribution and potentially causing fiat currency shortages or deficits, changes in digital asset value, and/or the like. Thus, the account management system 102 may predict the likelihood of significant changes in digital asset unit supply or distribution for the source digital asset and/or the target digital asset based at least in part on the present digital asset conversion and/or other conversion requests received in a current time period. Upon such a determination that a “run on points” situation is likely, the account management system 102 may communicate the same to a digital asset exchange system 106.

If the originally requested digital asset conversion does not satisfy the conversion conditions and thresholds, various actions may result. In the illustrated embodiment for example, a notification is generated and transmitted to the client device 104 at step/operation 602. The notification indicates to the end user that the originally requested digital asset conversion does not satisfy the conversion conditions and thresholds. The notification may accordingly comprise various messages describing the conversion conditions and thresholds, information specific to the originally requested digital asset conversion, reasons why the originally requested digital asset conversion does not satisfy the conversion conditions and thresholds, and/or the like.

In various embodiments, the digital asset conversion may be modified or cancelled. For example, the amount of source digital asset units to debit may be lowered to satisfy conversion thresholds, and the amount of fiat currency units or target digital asset units to credit may also be modified. As another example, another digital asset user account specific to the source digital asset unit may be selected for execution of the original digital asset conversion. In various embodiments, modifying the digital asset conversion comprises notifying the end user (e.g., via the client device 104) and receiving approval of the modified digital asset conversion. In some instances, the account management system 102 receives an indication to cancel the digital asset conversion from the end user. In some embodiments, the account management system 102 may modify the digital asset conversion by canceling the digital asset conversion and accordingly notifying the end user (e.g., via the client device 104) that the digital asset conversion was canceled for not satisfying the conversion thresholds. In some embodiments, the account management system 102 receives a request from the first digital asset exchange system 106A (or the second digital asset exchange system 106B in applicable instances) to cancel the requested digital asset conversion.

Otherwise, step/operation 604 may be performed. Step/operation 604 comprises generating and transmitting a conversion execution API query to the first digital asset exchange system 106A associated with the source digital asset. The conversion execution API query is configured to cause the first digital asset exchange system to debit an amount of source digital asset units from a source digital asset user account. In instances where the source digital asset is a liability digital asset (e.g., loyalty points, reward points), the first digital asset exchange system 106A may update the unit balance of the source digital asset user account to reflect a debit, or subtraction, of the amount of source digital asset units to debit. In other instances where the source digital asset is a cryptocurrency digital asset or cryptoasset (e.g., Bitcoin, Ethereum, Ripple, Litecoin, Dogecoin), the first digital asset exchange system 106A may execute a cryptoasset transaction (e.g., an on-chain transaction) such that cryptoasset units associated with the distributed ledger public key value and/or cryptocurrency address associated with the end user are transferred out of the distributed ledger public key value and/or a cryptocurrency address (e.g., to an operating cryptocurrency address of the first digital asset exchange system 106A). For example, the first digital asset exchange system 106A may commit an on-chain transaction record data object to a distributed ledger computing platform to execute the cryptocurrency transaction. In even further example instances, the source digital asset may be a single-unit digital asset, such as an NFT, and the digital asset exchange system 106 may debit the single-unit digital asset from the source digital asset user account by changing the ownership of the single-unit digital asset, or transferring the single-unit digital asset to another digital asset user account associated with another end user. Thus, in various embodiments, debiting an amount of source digital asset units from the source digital asset user account may comprise transferring the number of source digital asset units to another account, another end user, the digital asset exchange system 106, and/or the like.

Then at step/operation 605, a confirmation originating from the first digital asset exchange system 106A is received. The confirmation indicates that the amount of source digital asset units was debited from the source digital asset user account and may be a conversion execution API response. In various embodiments, the confirmation comprises additional information, such as a timestamp of the debit and if applicable, a recipient of the debited number of source digital asset units (e.g., recipient of an ownership token digital asset).

In instances when the originally requested conversion is between the source digital asset and the fiat currency, step/operation 606 may be performed. Step/operation 606 comprises executing a fiat currency transaction between a fiat currency central operating account and the fiat currency user account. In various embodiments, the account management system 102 and/or the entity operating the account management system 102 is associated with one or more fiat currency central operating accounts, each associated with a fiat currency balance, and the account management system 102 is configured to initiate, request, and/or execute fiat currency transactions. In various embodiments, the executed fiat currency transaction involves the transfer of fiat currency units from the account management system 102 and/or the entity operating the account management system 102 to the end user in response to the debiting of source digital asset units from the source digital asset user account. As such, various embodiments provide technical advantages by enabling the instantaneous, immediate, real-time, and/or the like conversion of digital assets, as the end user receives the resulting fiat currency promptly. It may be understood that the first digital asset exchange system 106A and/or the entity associated with the digital asset exchange system 106 (e.g., a liability holder entity) may be ultimately responsible for the payment of fiat currency units as a result of the debit of source digital asset units; however, the account management system 102 may be configured to transfer the fiat currency units in less time or in a more efficient manner.

The amount of fiat currency units transferred to the fiat currency user account is determined (e.g., by the account management system 102) based at least in part on the source conversion rate. In an example scenario, the end user receives the one-hundred-fifty fiat currency units within a short time period (e.g., milliseconds, seconds) from the debit of three-hundred source digital asset units based at least in part on a source conversion rate of two source digital asset units to one fiat currency unit. In some instances, the end user may not be explicitly informed that the credited fiat currency units originated from the account management system 102 and is simply aware of a credit of fiat currency units to the fiat currency user account as a result of the debit of source digital asset units. In various embodiments, the transfer of fiat currency units (e.g., between fiat currency central operating accounts of the account management system 102 and fiat currency user accounts of the end user) may be accomplished in various techniques or systems, such as an electronic funds transfer (EFT), a wire transfer, an Automated Clearing House (ACH) transfer, a Society for Worldwide Interbank Financial Telecommunication (SWIFT) transfer or an international money transfer, a Single Euro Payments Area (SEPA) transfer, and/or the like. In some instances, the fiat currency user accounts of the end user may be externally custodied, such as by an external banking institution operating an external banking system. As such, the account management system 102 may cause fiat currency units to be transferred into an internal/external fiat currency user account by generating and transmitting an API query or call to an external banking system managing the fiat currency user account. In various embodiments, executing the fiat currency transaction between the fiat currency central operating account and the fiat currency user account comprises receiving a confirmation (e.g., originating from an external banking system) that the fiat currency transaction was executed.

In other instances when the originally requested conversion is between the source digital asset and the target digital asset, step/operation 607 and step/operation 608 may be performed. That is, an amount of target digital asset units is credited to the end user. Step/operation 607 comprises generating and transmitting a second conversion execution API query to the second digital asset exchange system 106B associated with the target digital asset. The second conversion execution API query is configured to cause an amount of target digital asset units to be credited to a target digital asset user account. For example, the second digital asset exchange system 106B may update the unit balance of the second digital asset user account to reflect a credit, addition, deposit, and/or the like of the number of target digital asset units to credit. In some instances, the target digital asset may be a cryptoasset, and the second digital asset exchange system 106B may execute an on-chain transaction to credit the second digital asset user account with cryptoasset units. In various embodiments, the credit of target digital asset units may occur substantially concurrent or slightly subsequent to the debit of source digital asset units, advantageously enabling the end user to be in ownership of the desired target digital asset within a short period of time. Specifically, both the debit of source digital asset units and the credit of target digital asset units span a time period on a scale of milliseconds and/or seconds.

At step/operation 608, a confirmation originating from the second digital asset exchange system 106B is received. The confirmation indicates that the amount of target digital asset units was credited to the target digital asset user account and may be a conversion execution API response. In various embodiments, the confirmation comprises additional information, such as a timestamp of the credit and if applicable, a source of the debited amount of source digital asset units (e.g., an original owner of an ownership token digital asset). Thus, in instances when the originally requested conversion involves a source digital asset and a target digital asset, individual debits and credits of the source digital asset and the target digital asset may occur such that an end user may receive target digital assets.

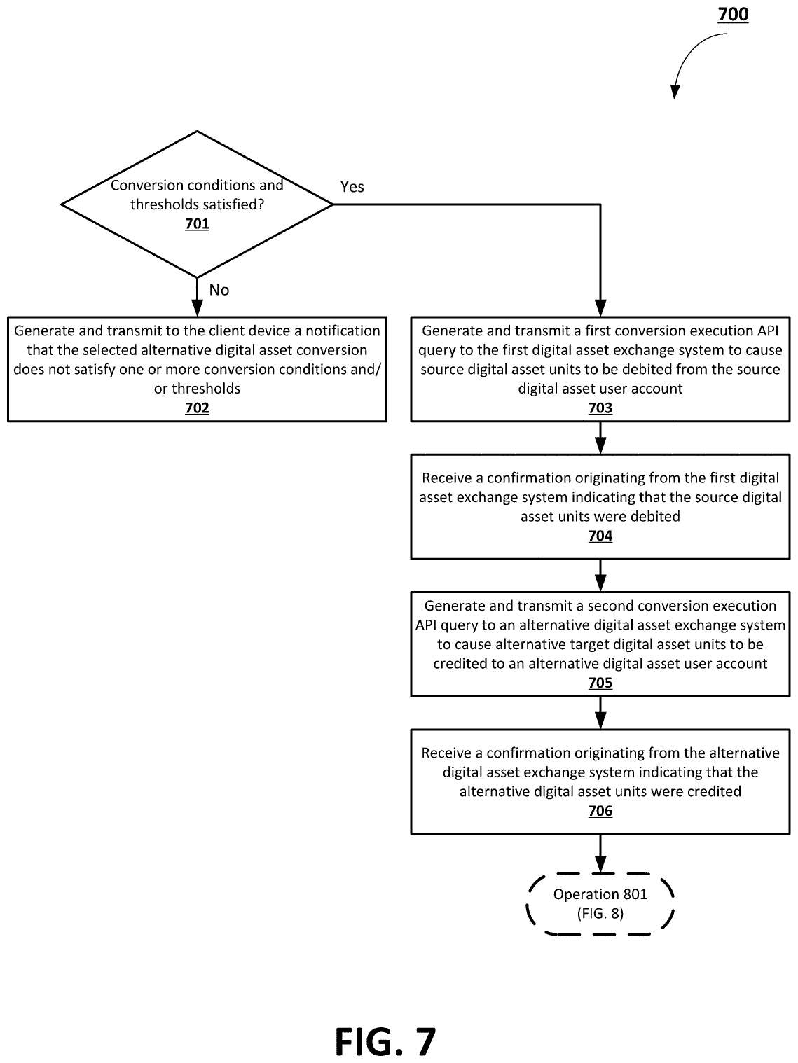

FIG. 7 illustrates a process 700 for executing a digital asset conversion, specifically an alternative digital asset conversion. Process 700 may be performed based at least in part on and responsive to receiving a selection of an alternative digital asset in step/operation 505, in various embodiments. In various embodiments, the account management system 102 comprises means, such as processing element 205, memories 210, 215, network interface 220, and/or the like, for performing each of the steps/operations of process 700 to execute the digital asset conversion of the source digital asset to a selected alternative digital asset.

Similar to the execution of the originally requested conversion, execution of the alternative digital asset conversion comprises determining whether the alternative digital asset conversion satisfies one or more conversion conditions and thresholds, such as in step/operation 701. As previously described, evaluation of such conversion conditions and thresholds may include determining whether the unit balance of the source digital asset user account is sufficient for the amount of source digital asset units to debit, determining whether the alternative digital asset conversion can be executed within established time periods, determining whether the alternative digital asset conversion satisfies various unit-based limits, user-based limits, and/or cohort-based limits, and determining the likelihood of a “run on points” situation or a situation involving significant amounts of digital asset units being debited/credited.

Upon determining that the alternative digital asset conversion does not satisfy one or more conversion conditions or thresholds, step/operation 702 may be performed. Step/operation 702 comprises generating and transmitting to the client device a notification that the alternative digital asset conversion does not satisfy one or more conversion conditions and/or thresholds. The notification may comprise one or more messages describing why the alternative digital asset conversion does not satisfy one or more conversion conditions and/or thresholds. In various embodiments, the alternative digital asset conversion may also be modified and/or cancelled. Specifically, the amount of source digital asset units to debit, the amount of alternative digital asset units to credit, the time of execution, and/or the like may be modified, for example.

Otherwise, the alternative digital asset conversion between the source digital asset and the selected alternative digital asset conversion proceeds to be executed. At step/operation 703, a first conversion execution API query is generated and transmitted to the first digital asset exchange system to cause an amount of source digital asset units to be debited from the source digital asset user account. At step/operation 704, a confirmation originating from the first digital asset exchange system 106A is received indicating that the source digital asset units were debited.

Then, the crediting of units of the selected alternative digital asset is performed. In various embodiments, the selection of an alternative digital asset specifies an amount of units of the selected alternative digital asset to credit and/or an amount of source digital asset units to debit. The crediting of the selected alternative digital asset units may be similar to the crediting of target digital asset units in instances when the originally requested digital asset conversion is selected and involves the target digital asset. Crediting of units of the selected alternative digital asset comprises step/operation 705, which includes generating and transmitting a second conversion execution API query to an alternative digital asset exchange system 106C. The alternative digital asset exchange system 106C is associated with the selected alternative digital asset and configured to credit an amount of units of the selected alternative digital asset to an alternative digital asset user account specific to the selected alternative digital asset. The second conversion execution API query is configured to cause the alternative digital asset exchange system 106C to credit a specific amount of units of the selected alternative digital asset to the alternative digital asset user account. Accordingly, the second conversion execution API query specifies the amount of units to credit and identifies the alternative digital asset user account (e.g., via the identifier token), in various embodiments. At step/operation 706, the account management system 102 then receives a confirmation originating from the alternative digital asset exchange system 106C indicating that units of the alternative digital asset were credited.

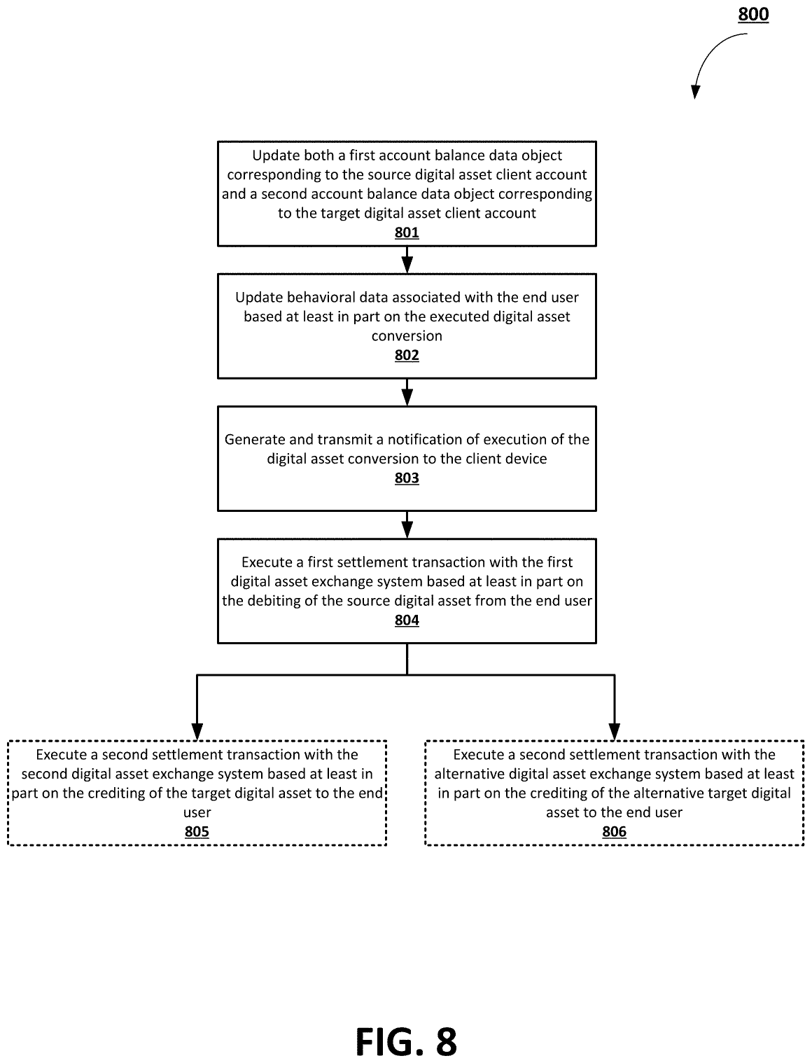

FIG. 8 illustrates a process 800 for further executing a digital asset conversion, such as the originally requested digital asset conversion or an alternative digital asset conversion involving an alternative digital asset. In various embodiments, the account management system 102 comprises means, such as processing element 205, memories 210, 215, network interface 220, and/or the like, for performing each of the steps/operations of process 800 to further execute a digital asset conversion, which may be a conversion of the source digital asset to the fiat currency, the target digital asset, or a selected alternative digital asset.

Process 800 comprises step/operation 801, which comprises updating a first account balance data object corresponding to the source digital asset user account, and updating a second account balance data object corresponding to either a fiat currency user account or a second digital asset user account. Specifically, the second account balance data object that is updated corresponds to (i) a fiat currency user account when the originally requested conversion involves the fiat currency and is executed, (ii) a digital asset user account specific to the target digital asset when the originally requested conversion involves the target digital asset and is executed, or (iii) a digital asset user account specific to a selected alternative digital asset when an alternative digital asset conversion is executed. In each instance, the first account balance data object is updated to reflect the debit of an amount of source digital asset units from the source digital asset user account, while the second account balance data object is updated to reflect the credit of an amount of fiat currency units, target digital asset units, or alternative digital asset units to a fiat currency user account or a digital asset user account. In various embodiments, the account management system 102 may store account balance data objects corresponding to various different accounts, such as in memories 210, 215.

In some embodiments, updating each account balance data object comprises generating and associating a transaction record data object with an account balance data object (e.g., the first account balance data object, the second account balance data object). A transaction record data object generated and associated with the first account balance data object may describe the debiting of source digital asset units (e.g., the amount of source digital asset units debited, timestamps of the time of debiting, identifiers for the source digital asset user account, identifiers for the end user). Similarly, a transaction record data object generated and associated with the second account balance data object may describe the crediting of fiat currency units, target digital asset units, or alternative digital asset units (e.g., the amount of units credited, the time of crediting, identifiers for the second digital asset user account, identifiers for the end user associated with the second digital asset user account). As the debiting of source digital asset units and the crediting of fiat currency units, target digital asset units, or alternative digital asset units are related within the execution of a digital asset conversion, the two transaction record data objects may be related and associated with each other. Accordingly, account balance data objects are updated to provide a transaction history or historical account activity including executed digital asset conversions.

In various embodiments, multiple different systems (e.g., one or more account management systems 102, one or more client devices 104, one or more digital asset exchange systems 106) may individually store an account balance data object for a source digital asset user account for the source digital asset and/or an account balance data object for a fiat currency user account and/or a second digital asset user account (e.g., specific for the target digital asset, specific for the alternative digital asset). In such embodiments, the account management system 102 may relay, broadcast, transmit, and/or the like a transaction record data object to other different systems, such that the other systems are informed of the debiting of source digital asset units and the crediting of fiat currency units, target digital asset units, or alternative digital asset units during the execution of a digital asset conversion. For example, the account balance data object for a digital asset user account may be a distributed ledger, and the account management system 102 commits a transaction record data object describing the debiting of digital asset units to the distributed ledger.

Step/operation 802 comprises updating behavioral data associated with the end user based at least in part on the executed digital asset conversion (e.g., the originally requested digital asset conversion, an alternative digital asset conversion). Behavioral data associated with a cohort including the end user may also be updated. As previously described, behavioral data is used in generating conversion behavior analytics data objects, which are communicated to digital asset exchange systems 106 to generate individualized and predictive conversion rates and are also used in identifying and selecting alternative digital assets predicted to be of interest to the end user. In various embodiments, updating behavioral data comprises recording the execution of the digital asset conversion, the time of execution of the digital asset conversion, conversion rates used for the execution of the digital asset conversion, demographic information and/or other information associated with the end user, and/or the like. In various embodiments, various predictive models, optimizations models, classification models, neural network models, supervised or unsupervised machine learning models, and/or the like may be updated, retrained, reconfigured, and/or the like with information of the executed digital asset conversion.

Step/operation 803 comprises generating and transmitting a notification of execution of the digital asset conversion to the client device 104. Again, the executed digital asset conversion is one of the originally requested digital asset conversion (involving the fiat currency or the target digital asset) or an alternative digital asset conversion (involving a selected alternative digital asset) based at least in part on selection by the end user. In various embodiments, the notification may be any communication (e.g., telephonic conversion, text message, e-mail, push notification, user interface) indicating to the end user that the conversion of the source digital asset to the target digital asset was executed and completed. The notification may be provided to the end user via an API response. The notification may include additional information regarding the digital asset conversion, such as identifiers for the digital asset user account and/or the fiat currency user account, the amount of source digital asset units debited, the amount of fiat currency units, target digital asset units, or alternative digital asset units credited, resulting balances of various user accounts, and/or the like.

Step/operation 804 comprises executing a first settlement transaction with the first digital asset exchange system 106A based at least in part on debiting of source digital asset units from the end user. Precisely, source digital asset units are debited from the source digital asset user account specific for the source digital asset. The first settlement transaction specifically involves the transfer of fiat currency units to a fiat currency central operating account associated with the account management system 102 from a fiat currency account associated with the first digital asset exchange system 106A. In various embodiments, the first settlement transaction may occur in relation to the debiting of the source digital asset units from the end user and may be understood as a settlement for the debiting of the source digital asset units. While conceptually, the debiting of source digital asset units from the end user would result in the end user receiving fiat currency (e.g., redeeming, exchanging source digital asset units for the fiat currency), the fiat currency is instead transferred to the fiat currency central operating account associated with the account management system 102 to be used for the purchase of target digital asset units. In various embodiments, executing the first settlement transaction between the account management system 102 and the first digital asset exchange system 106A comprises the account management system 102 receiving confirmation (e.g., originating from the first digital asset exchange system 106A, originating from an external banking system associated with an external banking entity or institution) that the first settlement transaction was executed.

As discussed, the first settlement transaction may be a settlement of fiat currency units, or a fiat currency settlement. The first settlement transaction involves the transfer of at least an amount of fiat currency units based at least in part on the conversion rate of the source digital asset and the amount of source digital asset units debited. In an example scenario, twenty source digital asset units were debited from the end user, and with a conversion rate of one source digital asset unit to ten fiat currency units, two-hundred fiat currency units are then transferred to the fiat currency central operating account associated with the account management system 102 in the first settlement transaction. In various embodiments, the transfer of fiat currency units may involve various techniques or systems, such as EFT, a wire transfer, an ACH transfer, a SWIFT or international money transfer, a SEPA transfer, and/or the like.

In various embodiments, the execution of the first settlement transaction is responsive to a settlement request transmitted and originating from the account management system 102 and received by the first digital asset exchange system 106A. The settlement request may indicate and identify the debiting of the source digital asset units from the end user as well as the source conversion rate at the time of the debiting. For example, the settlement request comprises a transaction identifier, a transaction record data object, a timestamp, and/or the like describing the debiting of the source digital asset units and/or the source conversion rate at the time of the debiting.

In various embodiments, the first settlement transaction involves the settlement for a plurality of debits of source digital asset units from a plurality of end users. That is, the account management system 102 may simultaneously or substantially at the same time receive requests for a digital asset conversion from a plurality of end users and cause the debiting of a source digital asset units from the plurality of end users within a configurable time period. For the conversions with the same source digital asset units, the account management system 102 may then generate and transmit a settlement request indicating the plurality of debits executed and associated source exchange rates, thereby requesting that the first settlement transaction involve the transfer of a sum of fiat currency units that would settle each debit of source digital asset units from the plurality of end users. In such instances, the settlement request may include line item details indicating and identifying each individual debit of source digital asset units within the configurable time period. As an example, the configurable time period may be a day, and the first settlement transaction involves the transfer of fiat currency units to settle a plurality of debits of source digital asset units within the same day. As such, the execution of a first settlement transaction or settlement with the first digital asset exchange system 106A provides various technical advantages. When the first settlement transaction settles more than one debit of source digital asset units, network traffic, bandwidth, data storage, and/or the like are conserved and reduced, with only one settlement being executed from more than one debit. Accordingly, less processing time of fiat currency transactions is spent, and multiple fiat currency settlements that would be individually processed are aggregated and condensed into one processed transaction.

In example scenarios where the originally requested digital asset conversion is between the source digital asset and the fiat currency and is executed, settlement of the digital asset conversion is then resolved with the first settlement transaction. From the end user's perspective during execution of the originally requested digital asset conversion between the source digital asset and the fiat currency, the debit of source digital asset units and the credit of fiat currency units occur within an extremely short and efficient time period. As described, the credit of fiat currency units originates from the fiat currency central operating account associated with the account management system 102, which then balanced or accounted for by the first settlement transaction.

However, in other example scenarios involving execution of the originally requested digital asset conversion with the target digital asset or the execution of an alternative digital asset conversion, a second fiat currency transaction is executed. That is, crediting of another digital asset during execution of a digital asset conversion requires a settlement transaction, or transfer of fiat currency units, with the digital asset exchange system 106 crediting the digital asset units. Specifically, fiat currency is transferred to the digital asset exchange system 106 for the credit of digital asset units.

Thus, step/operation 805 comprises executing a second settlement transaction with the second digital asset exchange system associated with the target digital asset based at least in part on the crediting of the target digital asset units to the end user. Step/operation 805 is specifically performed in scenarios where the originally requested digital asset conversion is selected by the end user and target digital asset units are credited to the end user. The second fiat currency transaction comprises the transfer of fiat currency units from the fiat currency central operating account associated with the account management system 102 to a fiat currency account associated with the second digital asset exchange system 106B. Thus, the second fiat currency transaction may be understood as a delayed purchase or settlement for the target digital asset units already credited, as the second fiat currency transaction may occur subsequent to the crediting of target digital asset units to the end user. In an example scenario, five-hundred target digital asset units were credited to the end user, and with the target exchange rate being one-hundred target digital asset units for USD $20, USD $100 is then transferred from the fiat currency central operating account associated with the account management system 102 to a fiat currency account associated with the second digital asset exchange system 106B. It may be appreciated that in some instances, the amount of fiat currency units transferred in the second settlement transaction may be the same amount of fiat currency units received from the first digital asset exchange system 106A for the debiting of source digital asset units. In various embodiments, the second fiat currency transaction may occur immediate subsequent to, within a configurable time period of, and/or simultaneous with the first fiat currency transaction such that a unit balance of the fiat currency central operating account remains greater than one or more configurable balance thresholds.

While in some embodiments, the second fiat currency transaction may be a settlement for the credit of target digital asset units to the end user, the second fiat currency transaction in other various embodiments may be a settlement for a plurality of credits of target digital asset units to a plurality of end users. In various embodiments then, the account management system 102 may settle a plurality of credits of target digital asset units to a plurality of end users that occurred within a configurable time period with one second fiat currency transaction, thereby increasing transaction efficiency, reducing transaction processing and communication resources, and/or the like.

Step/operation 806 comprises the execution of a second settlement transaction, although with the alternative digital asset exchange system associated with the selected alternative digital asset that credited alternative digital asset units. Step/operation 806 may only be performed for scenarios in which an alternative digital asset conversion is selected by the end user and executed. It may be appreciated that this second settlement transaction described by step/operation 806 may be similar to the second settlement transaction described by step/operation 805, albeit for the involvement of an alternative digital asset exchange system 106C to settle the crediting of alternative digital asset units.

b. Exemplary User Interfaces

Having thus described various functions, steps/operations, methods, processes, and/or the like for converting a first/source digital asset to a second/target digital asset, additional steps/operations are herein described in the context of various user interfaces. In various embodiments, the user interfaces provided and described in the present disclosure are configured to be provided via a client device 104 (e.g., via a display 316). In other embodiments, the user interfaces may be provided via the account management system 102, a digital asset exchange system 106, and/or other various systems or devices involved in the digital asset conversion.

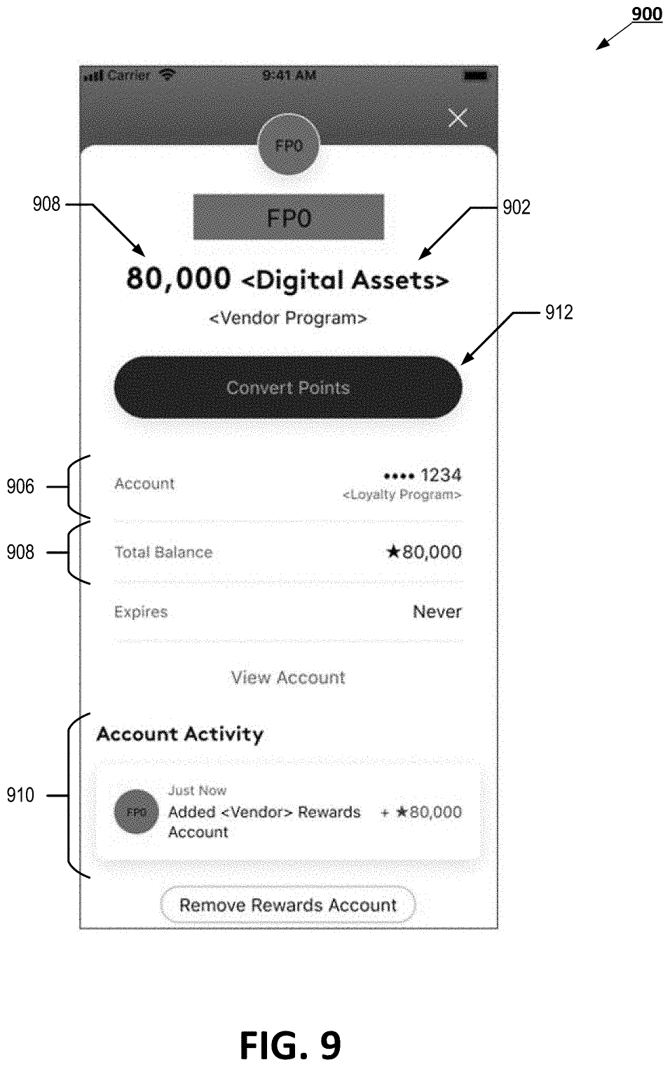

FIG. 9 provides a user interface 900 configured to enable an end user to request the initiation of a digital asset conversion of a digital asset to fiat currency. Using the user interface 900, the end user may request a digital asset conversion of a source digital asset 902 with a fiat currency or a target digital asset. Such a request may implicitly comprise a conversion rate request (e.g., a conversion rate request received by the account management system 102 in step/operation 401). As illustrated in FIG. 9, the user interface 900 identifies the source digital asset 902 and a source digital asset user account 906 associated with the end user and specific to the source digital asset 902. The user interface 900 may further identify an entity (e.g., a liability holder entity, “Vendor Program”) responsible for the distribution and management of the source digital asset 902.

User interface 900 indicates a source digital asset unit balance 908 associated with the source digital asset user account 906. The source digital asset unit balance 908 describes an amount of units of the source digital asset 902 currently in possession of or owned by the end user. In various embodiments, the user interface 900 may be generated using an account balance data object associated with the source digital asset user account 906, the account balance data object comprising information for the source digital asset user account 906, such as the source digital asset unit balance 908 and various identifiers (e.g., account number) for the source digital asset user account 906. In various embodiments, the account balance data object is further configured to describe historical account activity 910 associated with the source digital asset user account 906, and the user interface 900 may indicate such historical account activity 910. For example, in the illustrated embodiment, eighty-thousand units of the source digital asset 902 were previously credited to the source digital asset user account 906. Each item of the historical account activity 910 may be associated with a timestamp and may be indicated via the user interface 900 using the timestamp.

It may then be appreciated that the client device 104 generating and displaying the user interface 900 may have access to (e.g., receives from the account management system 102) the account balance data object corresponding to the source digital asset user account 906. In various embodiments, the client device 104 may request various information for the user interface 900 (e.g., source digital asset unit balance 908, historical account activity 910) from the account management system 102 when generating and/or updating the user interface 900. The account management system 102 may then retrieve such information from an account balance data object corresponding to the source digital asset user account 906 and provide such information to the client device 104.

As illustrated in FIG. 9, user interface 900 comprises a conversion initiation mechanism 912 (e.g., a button labelled “Convert Points”). The conversion initiation mechanism 912 may be configured to be selectable or interactable with by an end user of the client device 104, and the client device 104 may be configured to monitor for user interaction with the conversion initiation mechanism 912. User interaction with the conversion initiation mechanism 912 may represent the desire by an end user to initiate a digital asset conversion of the source digital asset 902 identified by the user interface 900. Responsive to user interaction with the conversion initiation mechanism 912, the client device 104 may generate and transmit a conversion rate request.

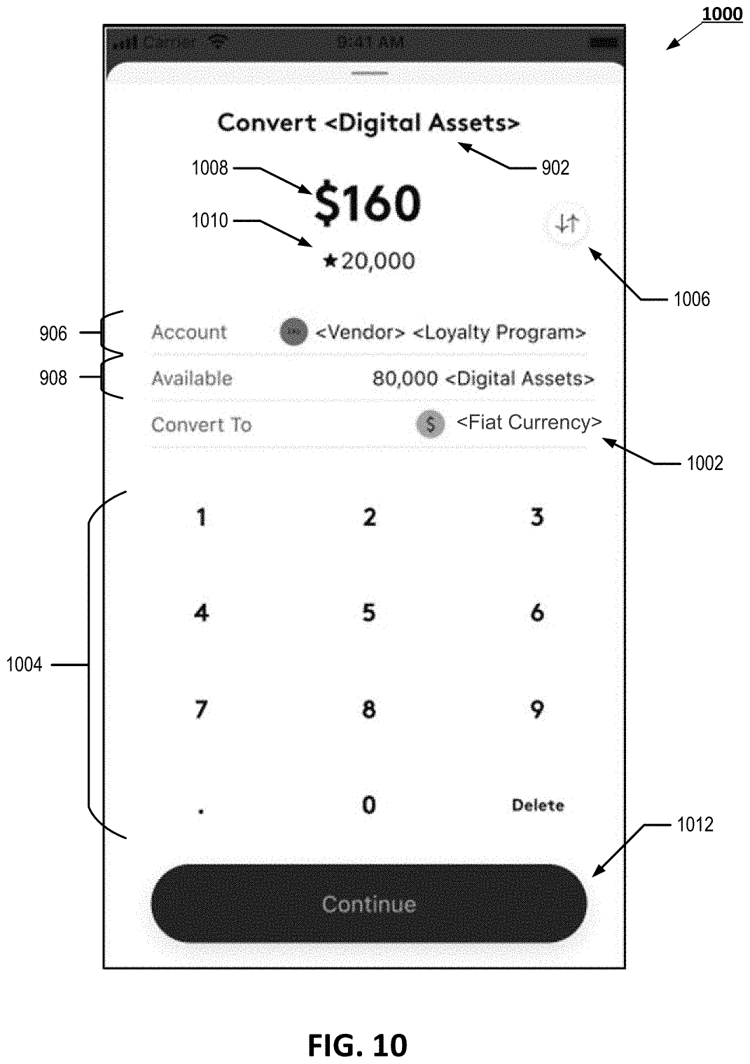

FIG. 10 provides an example user interface 1000 for providing the source conversion rate for the source digital asset 902 or an aggregated conversion rate for the source digital asset 902 and a target digital asset to the end user. As illustrated, the user interface 1000 identifies the source digital asset 902, as well as the source digital asset user account 906 and the source digital asset unit balance 908 associated with the source digital asset user account 906. In some instances, the user interface 1000 provides the source conversion rate for the source digital asset 902 when the end user requests the conversion of the source digital asset 902 to a fiat currency 1002, such as is shown in the illustrated embodiment (e.g., converting to USD). In some embodiments, the user interface 1000 is configured to enable the end user to select the fiat currency 1002. For example, the end user may select to be credited with U.S. dollars, E.U. euros, Chinese yen, English pounds, and/or the like for the digital asset conversion. As such, the user interface 1000 may display the fiat currency 1002 selected by the end user. In some embodiments, such selection may be indicated to the account management system 102 such that the account management system 102 is informed of the selection of the fiat currency 1002. In various other embodiments, the fiat currency 1002 may be based at least in part on a location associated with the end user. For example, the fiat currency 1002 may be US dollars if a real-time location (e.g., determined via a global navigation satellite system, global positioning system, and/or the like) is within a region where US dollars are accepted and/or are the main fiat currency. Alternatively, the fiat currency 1002 may be US dollars if a residential location or address of the end user is within a region where US dollars are accepted and/or are the main fiat currency.

Although not explicitly shown, user interface 1000 may alternatively provide an aggregated conversion rate for the source digital asset 902 and a target digital asset indicated by the end user. In such instances then, the user interface 1000 may identify the target digital asset (e.g., alternatively to the identified USD in the illustrated embodiment). User interface 1000 may be generated and displayed by client device 104 based at least in part on being provided the source conversion rate or the aggregated conversion rate by the account management system 102. User interface 1000 may be generated and displayed by client device 104 subsequent to user interaction by the end user with the conversion initiation mechanism 912 in user interface 900.

User interface 1000 comprises unit specification mechanisms 1004 (e.g., numerical buttons, a keypad) and an input selection mechanism 1006 (e.g., a button). In various embodiments, the unit specification mechanisms 1004 (e.g., numerical buttons, a keypad) are configured to enable an end user to specify one of (i) an amount of source digital asset units or (ii) an amount of fiat currency units or an amount of target digital asset units. In various embodiments, the unit specification mechanisms 1004 may be used in conjunction with the input selection mechanism 1006 to select whether user input or interaction with the unit specification mechanisms 1004 specifies the amount of source digital asset units or the amount of fiat currency units or target digital asset units. In the illustrated embodiment, user interface 1000 indicates an amount of fiat currency units 1008 and an amount of source digital asset units. Again, the illustrated embodiment describes an instance in which the end user requests the conversion of the source digital asset 902 to the fiat currency 1002 (instead of a target digital asset).

The amount of fiat currency units 1008 may be displayed in a format (e.g., font bolding, font color, font size) indicating that the amount of fiat currency units 1008 was specified by the end user via the unit specification mechanisms 1004 and/or that the unit specification mechanisms 1004 are presently configured to specify the amount of fiat currency units 1008 to credit from user input or interaction. Responsive to user interaction with the input selection mechanism 1006, however, the amount of source digital asset units 1010 may be displayed in a format indicating that the amount of source digital asset units 1010 was specified by the end user via the unit specification mechanisms 1004, and the unit specification mechanisms 1004 may responsively be configured to specify the amount of source digital asset units 1010 from user input or interaction.

The client device 104 may have access to an account balance data object corresponding to the source digital asset user account 906. In such embodiments, the client device 104 may determine whether the amount of source digital asset units 1010 is greater than or within some threshold of the source digital asset unit balance 908. For example, the client device 104 may generate a notification or alert (not explicitly illustrated) via user interface 1000 that the amount of source digital asset units 1010 specified by the end user via unit specification mechanisms 1004 is an invalid amount due to an insufficient balance or due to debiting of the amount of source digital asset units 1010 resulting in a source digital asset unit balance 908 lower than a configurable threshold.

While an end user may specify one of (i) the amount of source digital asset units 1010, or (ii) the amount of fiat currency units 1008 (e.g., via the unit specification mechanisms 1004 configured by input selection mechanism 1006), the respective other one of (i) the amount of source digital asset units 1010 or (ii) the amount of fiat currency units 1008 may be automatically and in real-time generated based at least in part on the source conversion rate for the source digital asset 902. For example, in the illustrated embodiment, the source conversion rate for the source digital asset 902 may indicate that one-hundred-twenty-five units of the source digital asset 902 is worth one unit of fiat currency (e.g., one U.S. dollar). Accordingly, user interaction with the unit specification mechanisms 1004 to specify one-hundred-and-sixty units of fiat currency 1002 causes the user interface 1000 to automatically, dynamically, and in real-time indicate twenty-thousand units of source digital asset 902 based at least in part on the source conversion rate for the source digital asset 902. Accordingly, the user interface 1000 is configured to provide the source conversion rate to the end user of the client device 104 on which the user interface 1000 is displayed. Likewise, in instances when the end user desires to convert the source digital asset to the target digital asset, the user interface 1000 is configured to automatically, dynamically, and in real-time, indicate a corresponding amount of source digital asset units or target digital asset units based at least in part on the aggregated conversion rate for the source digital asset and the target digital asset.

In various embodiments, user interface 1000 comprises a conversion unit confirmation mechanism 1012. The conversion unit confirmation mechanism 1012 is configured to enable an end user to confirm both the amount of fiat currency units 1008 (or target digital asset units in applicable instances) and the amount of source digital asset units 1010 as indicated by the user interface 1000, and thereby also to enable the end user to confirm the source conversion rate for the source digital asset 902 and/or the aggregated conversion rate. In some embodiments then, the conversion unit confirmation mechanism 1012 may cause a conversion execution request to be transmitted such that the account management system 102 receives the conversion execution request, indicating that the conversion rate for the source digital asset 902 has been provided to the end user and has also been approved and confirmed.

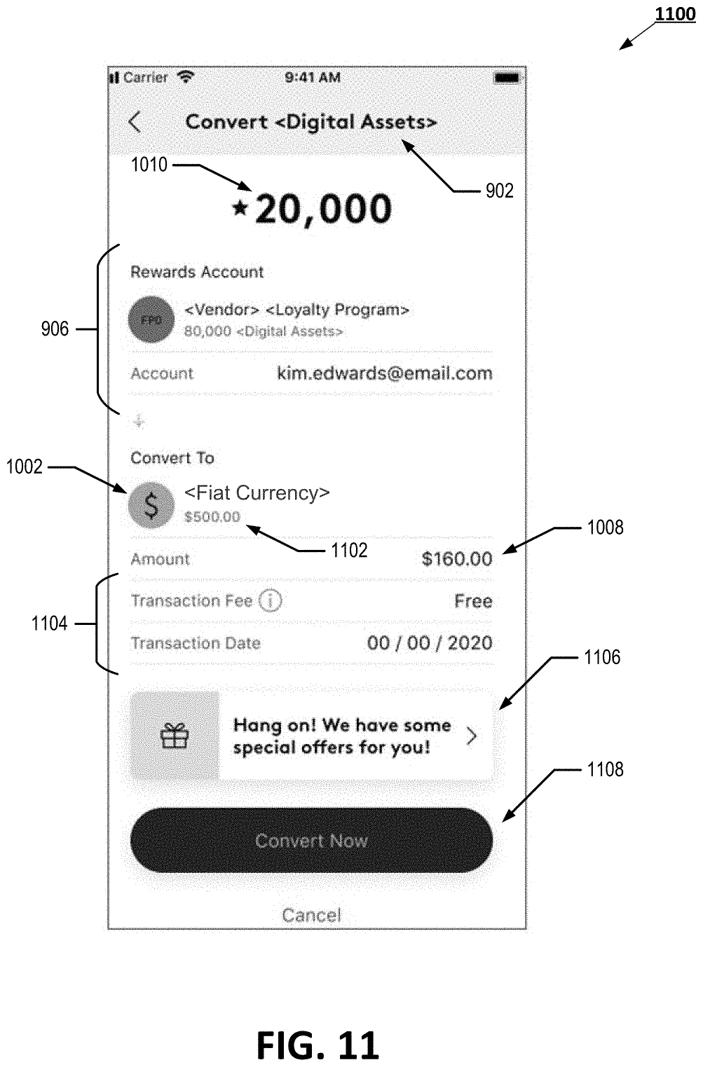

FIG. 11 illustrates a user interface 1100 that may be displayed responsive to user interaction with the conversion unit confirmation mechanism 1012. For example, the user interface 1100 may be configured to enable an end user to review and confirm multiple aspects and details of the requested digital asset conversion of the source digital asset 902 to the fiat currency 1002 or the target digital asset before the execution of the requested digital asset conversion. For example, the user interface 1100 enables the end user to confirm the amount of source digital asset units 1010, the amount of fiat currency units 1008, the amount of target digital asset units, the source digital asset user account 906 from which the source digital asset units will be debited, a fiat currency user account to which fiat currency units will be credited, a target digital asset user account to which the target digital asset units will be credited, a current (or resulting) fiat currency unit balance 1102 of a fiat currency user account, additional fees (e.g., in fiat currency), and/or various other information before the execution of the digital asset conversion. In the illustrated embodiment, the user interface 1100 enables the end user to confirm the requested digital asset conversion of twenty-thousand units of the source digital asset 902 to one-hundred-sixty units of the fiat currency 1002. User interface 1100 may further indicate additional conversion execution information 1104, such as any transaction fees and the date of the conversion, in the illustrated embodiment. For example, the account management system 102 may only execute digital asset conversion within certain time periods (e.g., hours), and as such, user interface 1100 may indicate the next available time at which the account management system 102 will execute the requested digital asset conversion. As previously described, the source conversion rate or the aggregated conversion rate may only be valid for execution within a configurable time period, or an execution time period. As such, in various embodiments, user interface 1100 may dynamically indicate to the end user the remaining time of the execution time period to execute the requested digital asset conversion.

User interface 1100 is also uniquely configured with an alternative conversion choice notification 1106, which displays the message “Hang on! We have some special offers for you!” in the illustrated embodiment. The alternative conversion choice notification 1106 is configured to alert the end user of one or more alternative digital asset conversion choices, each involving the conversion of the source digital asset 902 to an alternative digital asset. In various embodiments, the end user may interact with the alternative conversion choice notification 1106 to be presented with the one or more alternative digital asset conversion choices. Alternatively, the end user may interact with a conversion execution mechanism 1108 to cause the originally requested digital asset conversion (e.g., to fiat currency 1002 in the illustrated embodiment) to be executed. Interaction with the conversion execution mechanism 1108 may cause a conversion execution request to be transmitted.

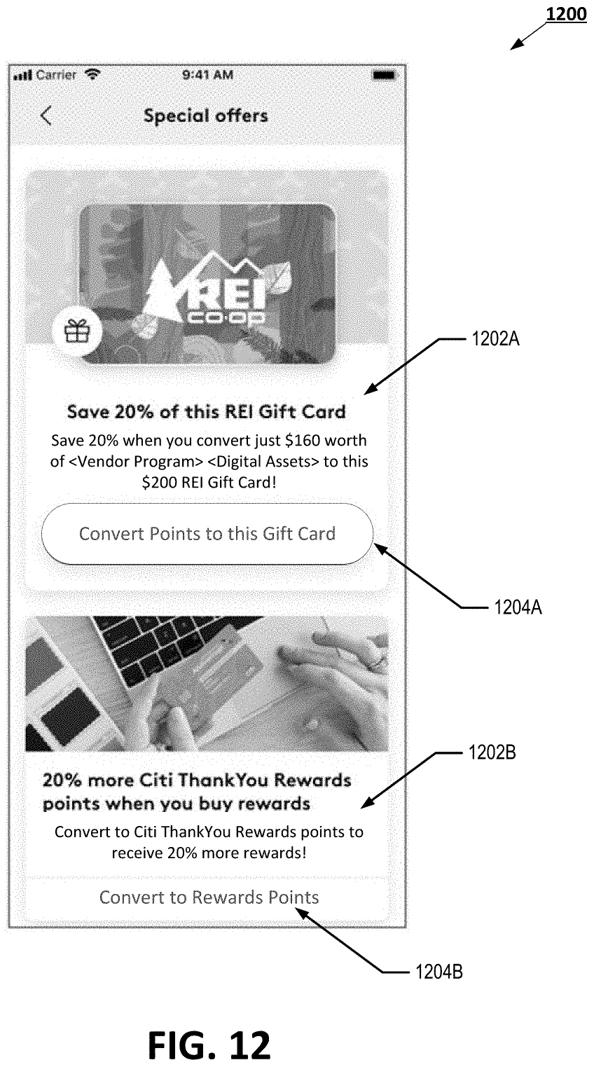

FIG. 12 provides a user interface 1200 configured to present one or more alternative digital asset conversion choices to the end user. User interface 1200 may be provided subsequent to user interaction with the alternative conversion choice notification 1106 provided in user interface 1100. As shown, each alternative digital asset conversion choice involves an alternative digital asset 1202. In the illustrated embodiment, the first alternative digital asset conversion choice involves a first alternative digital asset 1202A that is a closed-loop gift card, while the second alternative digital asset conversion choice involves a second alternative digital asset 1202B that is reward points. Each alternative digital asset conversion choice is presented with an execution selection mechanism 1204 configured to enable the end user to select a corresponding alternative digital asset conversion for execution. Selection of a corresponding alternative digital asset conversion may implicitly indicate that the end user is no longer interested in pursuing execution of the originally requested conversion. In various embodiments, each alternative digital asset conversion choice comprises a message comparing the corresponding alternative digital asset conversion to the originally requested digital asset conversion. In the illustrated embodiment, for example, the second alternative digital asset conversion choice indicates that twenty percent more units of the second alternative digital asset 1202B may be received compared to the one-hundred-sixty fiat currency units that would be received in the originally requested digital asset conversion.

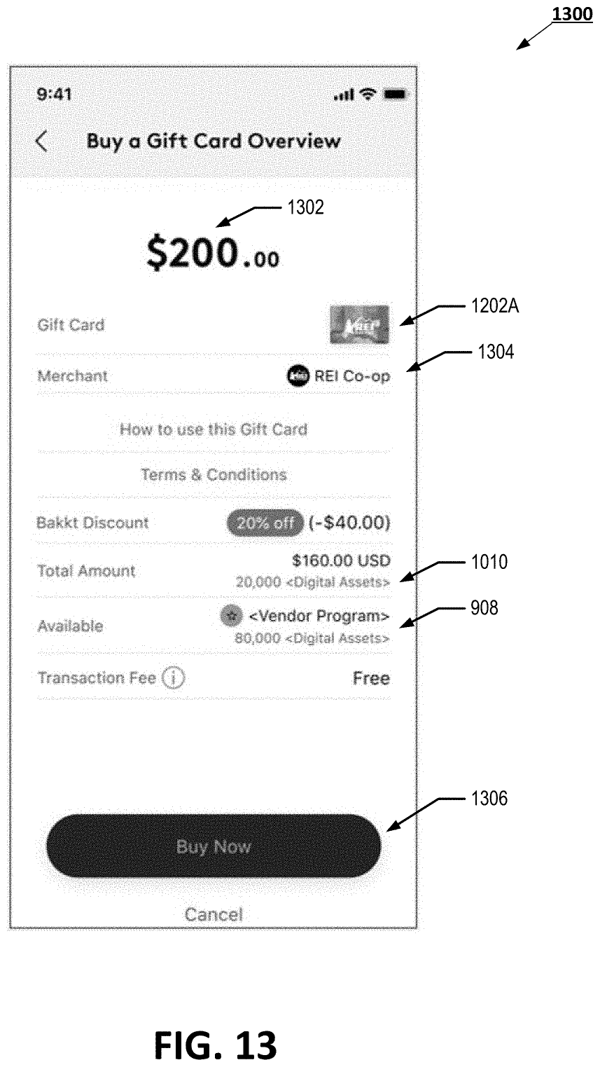

FIG. 13 provides a user interface 1300 configured to be provided responsive to user interaction with an execution selection mechanism 1204 of user interface 1200, thereby indicating the end user's interest in an alternative digital asset conversion. In the illustrated embodiment, for example, the end user has interacted with the first execution selection mechanism 1204A associated with the first alternative digital asset conversion choice involving the first alternative digital asset 1202A. Accordingly, user interface 1300 is configured to enable the end user to confirm and request execution of the first alternative digital asset conversion of the source digital asset 902 to the first alternative digital asset 1202A. In particular, the user interface 1300 identifies the first alternative digital asset 1202A and indicates an amount of alternative digital asset units 1302 that the end user will be credited with during the first alternative digital asset conversion. User interface 1300 may also identify the entity 1304 associated with, managing, and/or distributing the first alternative digital asset 1202A. Other details such as the amount of source digital asset units 1010 that will be debited, the source digital asset unit balance 908, transaction fees, available and/or applied discounts, and/or the like, are also indicated. User interface 1300 further comprises an alternative execution mechanism 1306 configure to enable the end user to request the execution of the selected alternative digital asset conversion.

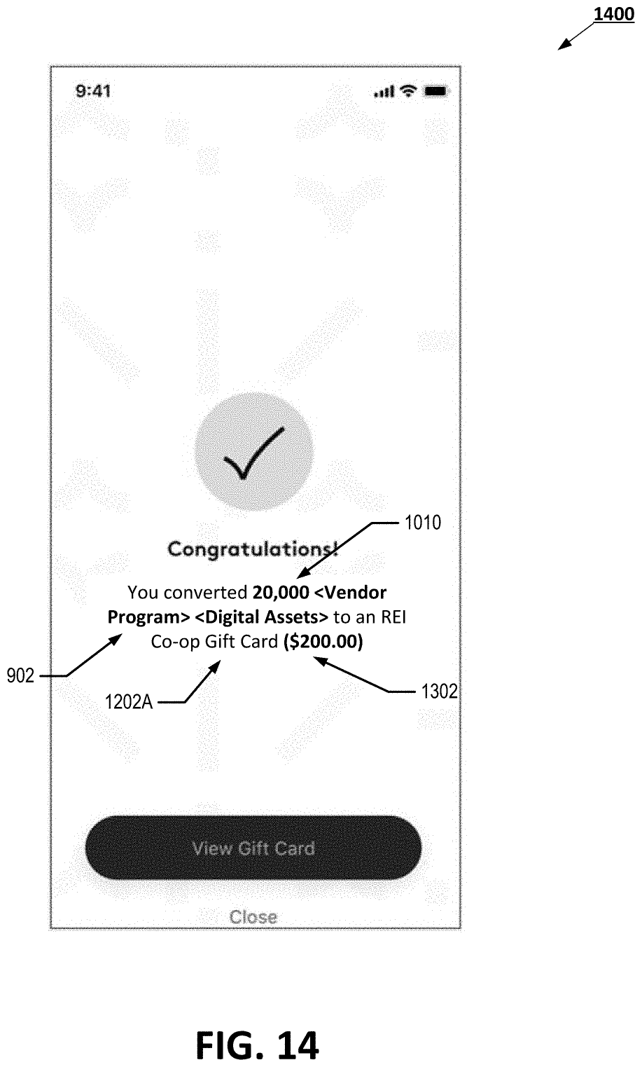

FIG. 14 provides a user interface 1400 configured to notify the end user that a digital asset conversion was executed and completed. User interface 1400 may be provided to notify the end user that the originally requested digital asset conversion (e.g., conversion of the source digital asset 902 to the fiat currency 1002) was executed in instances when the end user requested the execution of the originally requested digital asset conversion (and does not select an alternative digital asset conversion). User interface 1400 may also be provided, such as in the illustrated embodiment, to notify the end user that the alternative digital asset conversion was executed in instances when the end user selects and requests the alternative digital asset conversion. User interface 1400 may be configured to specifically indicate the amount of source digital asset units debited during the executed conversion and the amount of fiat currency units, target digital asset units, or alternative digital asset units credited during the executed conversion.

Subsequent to user interface 1400, an updated user interface similar to user interface 900 may be provided via the client device 104. Various information within the updated user interface may reflect the executed and completed conversion. For example, the executed conversion (e.g., the originally requested digital asset conversion, the selected alternative digital asset conversion) may be identified and described in the historical account activity 910 with a timestamp associated with the execution of the conversion. An account balance data object corresponding to the source digital asset user account 906 may be updated subsequent or during the execution of the digital asset conversion. For example, a transaction record data object describing the conversion may be generated and stored with the account balance data object. Accordingly, the client device 104 may generate and provide the updated user interface based at least in part on the updated account balance data object.

### VI. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method comprising:
receiving, using one or more processors, a first digital asset conversion request indicating a source digital asset and one of (i) a fiat currency or (ii) a target digital asset, wherein the first digital asset conversion request is associated with a first timepoint;
determining, using the one or more processors, a first source conversion rate for the source digital asset and the fiat currency based at least in part on:
generating and transmitting a first source conversion rate application programming interface (API) request, wherein the first source conversion rate API request indicates a source digital asset and comprises an identifier token associated with an end user, and
receiving a first source conversion rate API response comprising the first source conversion rate for the source digital asset and the fiat currency;
responsive to determining that a first configurable time period has elapsed since the first timepoint, determining, using the one or more processors, a second source conversion rate for the source digital asset and the fiat currency based at least in part on generating and transmitting a second source conversion rate API request and receiving a second source conversion rate API response comprising the second source conversion rate for the source digital asset and the fiat currency;
identifying, using the one or more processors, one or more alternative digital assets based at least in part on the identifier token associated with the end user, each alternative digital asset being different from the target digital asset;
for each alternative digital asset, determining, using the one or more processors, an alternative conversion rate for a corresponding alternative digital asset and the fiat currency based at least in part on:
generating and transmitting an alternative conversion rate API request, wherein the first alternative conversion rate API request indicates the corresponding alternative digital asset and comprises an identifier token associated with the end user, and
receiving an alternative conversion rate API response comprising the alternative conversion rate for the corresponding alternative digital asset and the fiat currency;
for each alternative digital asset, generating, using the one or more processors, an aggregated conversion rate for the source digital asset and the corresponding alternative digital asset based at least in part on the second source conversion rate and a corresponding alternative conversion rate;
providing, using the one or more processors, an indication of the one or more alternative digital assets and each corresponding aggregated conversion rate for display via a client device, wherein the indication is provided in response to the first digital asset conversion request; and
responsive to receiving a second digital asset conversion request at a second timepoint indicating (i) a selected alternative digital asset of the one or more alternative digital assets, (ii) both a source digital asset user account and an alternative digital asset user account each identifiable by the identifier token associated with the end user, and (iii) an amount of source digital asset units:
executing, using the one or more processors, a digital asset conversion for the second digital asset conversion request within a second configurable time period, wherein executing the digital asset conversion comprises causing debiting of the amount of source digital asset units from the source digital asset user account and causing crediting of an amount of units of the selected alternative digital asset to the alternative digital asset user account,
dynamically providing, using the one or more processors, a notification of execution of the digital asset conversion via the client device, and
updating, using the one or more processors, a first account balance data object associated with the source digital asset user account and a second account balance data object associated with the alternative digital asset user account based at least in part on the digital asset conversion.

2. The computer-implemented method of claim 1, wherein identifying the one or more alternative digital assets is further based at least in part on a conversion behavior analytics data object comprising behavioral data associated with the end user and/or a conversion behavior cohort including the end user, at least a portion of the behavioral data describing historical usage of one or more different digital assets.

3. The computer-implemented method of claim 2, wherein the one or more alternative digital assets are identified based at least in part on providing the conversion behavior analytics data object and/or the identifier token associated with the end user to a predictive machine learning model configured to determine a predicted level of interest of the end user in an alternative digital asset.

4. The computer-implemented method of claim 2, wherein the alternative conversion rate API request further comprises the conversion behavior analytics data object, and wherein the alternative conversion rate for the corresponding alternative digital asset and the fiat currency is generated based at least in part on providing the conversion behavior analytics data object to a predictive machine learning model configured to determine a likelihood of the end user requesting a digital asset conversion involving the alternative conversion rate.

5. The computer-implemented method of claim 1, wherein the one or more alternative digital assets are identified based at least in part on:
transmitting a request comprising at least the identifier token associated with the end user and an indication of an amount of fiat currency units to a plurality of digital asset exchange systems, the request configured to cause the plurality of digital asset exchange systems to determine whether an alternative digital asset should be offered to the end user; and
receiving one or more indications of an alternative digital asset to be offered to the end user originating from the plurality of digital asset exchange systems.

6. The computer-implemented method of claim 1, wherein the amount of units of the selected alternative digital asset is determined based at least in part on the aggregated conversion rate corresponding to the selected alternative digital asset and the amount of source digital asset units.

7. The computer-implemented method of claim 1, wherein the identifier token associated with the end user is federated and configured to identify each of the source digital asset user account and the alternative digital asset user account associated with the end user.

8. The computer-implemented method of claim 1, wherein providing the indication of the one or more alternative digital assets and each corresponding aggregated conversion rate comprises generating a user interface comprising one or more interactable mechanisms each associated with an alternative digital asset and configured to enable an end user to select an alternative digital asset.

9. The computer-implemented method of claim 8, wherein the user interface comprises one or more messages each comparing the aggregated conversion rate for a corresponding alternative digital asset to the second source conversion rate for the source digital asset and/or a target conversion rate for the target digital asset.

10. The computer-implemented method of claim 1, wherein updating the first account balance data object and the second account balance data object comprises generating a transaction record data object describing the debiting of the amount of source digital asset units from the source digital asset user account and/or the crediting of the amount of units of the selected alternative digital asset to the alternative digital asset user account, and associating the transaction record data object with the first account balance data object and/or the second account balance data object.

11. The computer-implemented method of claim 1, wherein executing the digital asset conversion is associated with (i) the execution of a first settlement transaction with a first digital asset exchange system associated with the source digital asset and configured to debit source digital asset units from the source digital asset user account and (ii) the execution of a second settlement transaction with a second digital asset exchange system associated with the selected alternative digital asset and configured to credit units of the selected alternative digital asset to the alternative digital asset user account.

12. A system comprising one or more memory storage areas and one or more processors, the system configured for:
receiving a first digital asset conversion request indicating a source digital asset and one of (i) a fiat currency or (ii) a target digital asset, wherein the first digital asset conversion request is associated with a first timepoint;
determining a first source conversion rate for the source digital asset and the fiat currency based at least in part on:
generating and transmitting a first source conversion rate application programming interface (API) request, wherein the first source conversion rate API request indicates a source digital asset and comprises an identifier token associated with an end user, and
receiving a first source conversion rate API response comprising the first source conversion rate for the source digital asset and the fiat currency;
responsive to determining that a first configurable time period has elapsed since the first timepoint, determining a second source conversion rate for the source digital asset and the fiat currency based at least in part on generating and transmitting a second source conversion rate API request and receiving a second source conversion rate API response comprising the second source conversion rate for the source digital asset and the fiat currency;
identifying one or more alternative digital assets based at least in part on the identifier token associated with the end user, each alternative digital asset being different from the target digital asset;
for each alternative digital asset, determining an alternative conversion rate for a corresponding alternative digital asset and the fiat currency based at least in part on:
generating and transmitting an alternative conversion rate API request, wherein the first alternative conversion rate API request indicates the corresponding alternative digital asset and comprises an identifier token associated with the end user, and
receiving an alternative conversion rate API response comprising the alternative conversion rate for the corresponding alternative digital asset and the fiat currency;
for each alternative digital asset, generating an aggregated conversion rate for the source digital asset and the corresponding alternative digital asset based at least in part on the second source conversion rate and a corresponding alternative conversion rate;
providing an indication of the one or more alternative digital assets and each corresponding aggregated conversion rate for display via a client device, wherein the indication is provided in response to the first digital asset conversion request; and
responsive to receiving a second digital asset conversion request at a second timepoint indicating (i) a selected alternative digital asset of the one or more alternative digital assets, (ii) both a source digital asset user account and an alternative digital asset user account each identifiable by the identifier token associated with the end user, and (iii) an amount of source digital asset units:
executing a digital asset conversion for the second digital asset conversion request within a second configurable time period, wherein executing the digital asset conversion comprises causing debiting of the amount of source digital asset units from the source digital asset user account and causing crediting of an amount of units of the selected alternative digital asset to the alternative digital asset user account,
dynamically providing a notification of execution of the digital asset conversion via the client device, and
updating a first account balance data object associated with the source digital asset user account and a second account balance data object associated with the alternative digital asset user account based at least in part on the digital asset conversion.

13. The system of claim 12, wherein identifying the one or more alternative digital assets is further based at least in part on a conversion behavior analytics data object comprising behavioral data associated with the end user and/or a conversion behavior cohort including the end user, at least a portion of the behavioral data describing historical usage of one or more different digital assets.

14. The system of claim 13, wherein the one or more alternative digital assets are identified based at least in part on providing the conversion behavior analytics data object and/or the identifier token associated with the end user to a predictive machine learning model configured to determine a predicted level of interest of the end user in an alternative digital asset.

15. The system of claim 13, wherein the alternative conversion rate API request further comprises the conversion behavior analytics data object, and wherein the alternative conversion rate for the corresponding alternative digital asset and the fiat currency is generated based at least in part on providing the conversion behavior analytics data object to a predictive machine learning model configured to determine a likelihood of the end user requesting a digital asset conversion involving the alternative conversion rate.

16. The system of claim 12, wherein the one or more alternative digital assets are identified based at least in part on:
transmitting a request comprising at least the identifier token associated with the end user and an indication of an amount of fiat currency units to a plurality of digital asset exchange systems, the request configured to cause the plurality of digital asset exchange systems to determine whether an alternative digital asset should be offered to the end user; and
receiving one or more indications of an alternative digital asset to be offered to the end user originating from the plurality of digital asset exchange systems.

17. The system of claim 12, wherein the amount of units of the selected alternative digital asset is determined based at least in part on the aggregated conversion rate corresponding to the selected alternative digital asset and the amount of source digital asset units.

18. The system of claim 12, wherein the identifier token associated with the end user is federated and configured to identify each of the source digital asset user account and the alternative digital asset user account associated with the end user.

19. A computer program product comprising at least one non-transitory computer-readable storage medium having computer-readable program code portions stored therein, the computer-readable program code portions comprising executable portions configured for:
receiving a first digital asset conversion request indicating a source digital asset and one of (i) a fiat currency or (ii) a target digital asset, wherein the first digital asset conversion request is associated with a first timepoint;
determining a first source conversion rate for the source digital asset and the fiat currency based at least in part on:
generating and transmitting a first source conversion rate application programming interface (API) request, wherein the first source conversion rate API request indicates a source digital asset and comprises an identifier token associated with an end user, and
receiving a first source conversion rate API response comprising the first source conversion rate for the source digital asset and the fiat currency;
responsive to determining that a first configurable time period has elapsed since the first timepoint, determining a second source conversion rate for the source digital asset and the fiat currency based at least in part on generating and transmitting a second source conversion rate API request and receiving a second source conversion rate API response comprising the second source conversion rate for the source digital asset and the fiat currency;
identifying one or more alternative digital assets based at least in part on the identifier token associated with the end user, each alternative digital asset being different from the target digital asset;
for each alternative digital asset, determining an alternative conversion rate for a corresponding alternative digital asset and the fiat currency based at least in part on:
generating and transmitting an alternative conversion rate API request, wherein the first alternative conversion rate API request indicates the corresponding alternative digital asset and comprises an identifier token associated with the end user, and
receiving an alternative conversion rate API response comprising the alternative conversion rate for the corresponding alternative digital asset and the fiat currency;
for each alternative digital asset, generating an aggregated conversion rate for the source digital asset and the corresponding alternative digital asset based at least in part on the second source conversion rate and a corresponding alternative conversion rate;
providing an indication of the one or more alternative digital assets and each corresponding aggregated conversion rate for display via a client device, wherein the indication is provided in response to the first digital asset conversion request; and
responsive to receiving a second digital asset conversion request at a second timepoint indicating (i) a selected alternative digital asset of the one or more alternative digital assets, (ii) both a source digital asset user account and an alternative digital asset user account each identifiable by the identifier token associated with the end user, and (iii) an amount of source digital asset units:
executing a digital asset conversion for the second digital asset conversion request within a second configurable time period, wherein executing the digital asset conversion comprises causing debiting of the amount of source digital asset units from the source digital asset user account and causing crediting of an amount of units of the selected alternative digital asset to the alternative digital asset user account,
dynamically providing a notification of execution of the digital asset conversion via the client device, and
updating a first account balance data object associated with the source digital asset user account and a second account balance data object associated with the alternative digital asset user account based at least in part on the digital asset conversion.

20. The computer program product of claim 19, wherein the one or more alternative digital assets are identified based at least in part on:
transmitting a request comprising at least the identifier token associated with the end user and an indication of an amount of fiat currency units to a plurality of digital asset exchange systems, the request configured to cause the plurality of digital asset exchange systems to determine whether an alternative digital asset should be offered to the end user; and
receiving one or more indications of an alternative digital asset to be offered to the end user originating from the plurality of digital asset exchange systems.
